(19) United States
(12) Patent Application Publication
(10) Pub. No.: US 2018/0262758 A1
(43) Pub. Date: Sep. 13, 2018

(54) Compression Methods and Systems for Near-Eye Displays

(71) Applicant: Ostendo Technologies, Inc., Carlsbad, CA (US)

(72) Inventors: Hussein S. El-Ghoroury, Carlsbad, CA (US); Danillo B. Graziosi, San Jose, CA (US); Zahir Y. Alpaslan, San Marcos, CA (US)

(73) Assignee: Ostendo Technologies, Inc., Carlsbad, CA (US)

(21) Appl. No.: 15/912,888

(22) Filed: Mar. 6, 2018

Related U.S. Application Data
(60) Provisional application No. 62/468,718, filed on Mar. 8, 2017.

(51) Int. Cl. H04N 19/124; H04N 19/44; H04N 19/60; G06F 3/01

(52) U.S. Cl. CPC H04N 19/124; G06F 3/012; H04N 19/60; H04N 19/44

(57) ABSTRACT

Image compression methods for near-eye display systems that reduce the input bandwidth and the system processing resource are disclosed. High order basis modulation, dynamic gamut, light field depth sampling and image data word-length truncation and quantization aiming at matching the human visual system angular, color and depth acuity coupled with use of compressed input display enable a high fidelity visual experience in near-eye display systems suited for mobile applications at a substantially reduced input interface bandwidths and processing resources.

### CROSS-REFERENCE TO RELATED APPLICATIONS

This application claims the benefit of U.S. Provisional Patent Application No. 62/468,718 filed Mar. 8, 2017.

### BACKGROUND OF THE INVENTION

### 1. Field of the Invention

This invention relates generally to compression methods for imaging systems, more particularly, image and data compression methods for head-mounted or near-eye display systems, collectively referred to herein as near-eye display systems.

### 2. Prior Art

Near-eye display devices have recently been gaining broad public attention. Near-eye display devices are not new, and many prototypes and commercial products can be traced back to the 1960's, but the recent advances in networked computing, embedded computing, display technology and optics design have renewed the interest in such devices. Near-eye display systems are usually coupled with a processor (embedded or external), tracking sensors for data acquisition, display devices and the necessary optics. The processor is typically responsible for handling the data acquired from sensors and generate data to be displayed as virtual images in the field of view of one or both eyes of the user. This data can range from simple alert messages or 2D information charts to complex floating animated 3D objects.

Two classes of near-eye display have recently gained a great deal of attention; namely, near-eye augmented reality (AR) and virtual reality (VR) displays, as the next generation displays that will present viewers with “life like” visual experience. In addition, near-eye AR displays are viewed as the ultimate means to present mobile viewers with high resolution 3D content that will blend into the viewers' ambient reality scene to expand the viewers' access to information on the go. The primary goal of AR displays is to transcend the viewing limitations of current mobile displays and offer a viewing extent that is not limited by the physical limitations of the mobile devices while not reducing the users' mobility. Near-eye VR displays, on the other hand, are envisioned to present viewers with 360° 3D cinematic viewing experience that immerses the viewer into the viewed content. Both AR and VR display technologies are viewed as “the next computing platform” behind the succession of the mobile phone and the personal computer that will extend the growth of the mobile users' information access and the growth of the information market and businesses that provide it. Herein AR/VR displays will frequently be referred to as “near-eye” displays to emphasis that fact that the methods of this invention apply to near-eye displays in general and are not limited to AR/VR displays per se.

The main shortcomings of the existing near-eye AR and VR displays include: motion sickness caused by low refresh rate display technology; eye strain and nausea caused by vergence accommodation conflict (VAC); and achieving eye limited resolution in a reasonably wide field of view (FOV). Existing attempts at solving these shortcomings include: using displays with higher refresh rate; using displays with more pixels (higher resolution); or making use of multiple displays or image planes. The common theme among all these attempts is the need for higher input data bandwidth. To cope with the higher data bandwidth without adding bulkiness, complexity and excessive power consumption to a near-eye display system requires new compression methods. The use of compression is the usual solution for dealing with high-volume data, but the requirements of near-eye displays are unique and transcend what can be accomplished by conventional video compression algorithms. Video compression for near-eye display has to achieve higher compression ratios than what is offered by existing compression schemes, with the added requirements of extremely low power consumption and low latency.

The high compression ratio, low latency and low power consumption constraints of near-eye displays requires new approaches to data compression such as compressed capture and display as well as data compression schemes that leverage the human visual system (HVS) capabilities. It is therefore an objective of this invention to introduce methods for near-eye compression that overcome the limitations and weaknesses of the prior art, thus making it feasible to create a near-eye display that can meet the stringent mobile device design requirements in compactness and power consumption and offer the users of such devices enhanced visual experience of either 2D or 3D contents over a wide angular extent. Additional objectives and advantages of this invention will become apparent from the following detailed description of a preferred embodiment thereof that proceeds with reference to the accompanying drawings.

There are numerous prior art that describe methods for near-eye displays. As a typical example, Maimone, Andrew, and Henry Fuchs. “Computational augmented reality eyeglasses.” In Mixed and Augmented Reality (ISMAR), 2013 IEEE International Symposium on, pp. 29-38. IEEE, 2013 describes a computational augmented reality (AR) display. Although the described near-eye display prototype that utilizes LCDs to recreate the light field via stacked layers, it does not deal with the data compression and low latency requirements. This AR display also achieves a non-encumbering format, with a wide field of view and allows mutual occlusion and focal depth cues. However, the process to determine the LCD layer patterns is based on computationally intensive tensor factorization that is very time and power consuming. This AR display also has significantly reduced brightness due to the use of light blocking LCDs. This is yet another example of how the display technology influences the performance of near-eye display and how the prior art falls short in resolving all the issues presented in the near-eye display realm.

Typical prior art near-eye display systems 100, depicted in FIG. 1a and FIG. 1b, are composed of a combination of elements such as a processor, which can be an embedded processor 102, or an external processor 107, an eye and head tracking element 210, a display device 103 and optics 104 for magnification and relay of the display image into the Human Visual System (HVS) 106. The processor, either 102 (FIG. 1a) or 107 (FIG. 1b), handles the sensory data acquired from the eye and head tracking element 210 and generates the corresponding image to be displayed by the display 103. This data processing occurs internally in the near-eye device with embedded processor 102 (FIG. 1a) or such processing can be performed remotely by an external processor 107 (FIG. 1b). The latter approach allows the use of more powerful processors such as latest generation CPUs, GPUs and task-specific processing devices to handle the incoming tracking data and send the corresponding image via a Personal Area Network (PAN) 108 to the near-eye display 109. Using an external processor has the advantage that the system can make use of a more powerful image remote processor 107 that possesses the processing throughput and memory needed to handle image processing without burdening the near-eye display system 109. On the other hand, transmitting the data via a PAN has its own challenges, such as the demand of low latency high-resolution video transmission bandwidth. Although new low-delay protocols for video transmission protocols in PAN (see Razavi, R.; Fleury, M.; Ghanbari, M., “Low-delay video control in a personal area network for augmented reality,” in Image Processing, IET, vol. 2, no. 3, pp. 150-162, June 2008) could enable the use of external processors 107 for near-eye display image generation to make high-quality immersive stereoscopic VR displays possible, such PAN protocols fail to cope with the high bandwidth data requirement for the new generation of near-eye AR and VR displays aiming to present the viewer with high resolution 3D and VAC-free viewing experience.

Nevertheless, using a more advanced display technology imposes new challenges for the entire system. New imaging methods require an increased amount of data to be generated and transmitted to the display, and due to the restrictions in size, memory and latency of the near-eye display, traditional compression methods used to handle increased amounts of data are no longer suited. Therefore, new methods to generate, compress and transmit data to near-eye displays are needed.

### BRIEF DESCRIPTION OF THE DRAWINGS

In the following description, like drawing reference numerals are used for the like elements, even in different drawings. The matters defined in the description, such as detailed construction and elements, are provided to assist in a comprehensive understanding of the exemplary embodiments. However, the present invention can be practiced without those specifically defined matters. Also, well-known functions or constructions are not described in detail since they would obscure the invention with unnecessary detail. In order to understand the invention and to see how it may be carried out in practice, a few embodiments of it will now be described, by way of non-limiting example only, with reference to accompanying drawings, in which:

FIG. 1a illustrates a block diagram of a prior art near-eye display system incorporating an embedded processor.

FIG. 1b illustrates a block diagram of a prior art near-eye display system incorporating a connected external processor.

FIG. 2a illustrates a block diagram of the near-eye display system of this invention, with an embedded processor.

FIG. 2b illustrates a block diagram of the near-eye display system of this invention, with an external processor.

FIG. 3a illustrates a functional block diagram of the encoder that apply the Visual Decompression capabilities of the compressed display within the context of the near-eye display systems of this invention.

FIG. 3b illustrates the basis coefficient modulation of the Visual Decompression methods of this invention.

FIG. 3c illustrates the basis coefficient truncation of the Visual Decompression methods of this invention.

FIG. 4a illustrates the field of view (FOV) regions around the viewer's gaze point used by the Foveated Visual Decompression methods of this invention.

FIG. 4b illustrates a block diagram of a near-eye display system incorporating the Foveated Visual Decompression methods of this invention.

FIG. 4c illustrates the basis coefficient truncation of the “Foveated Visual Decompression” methods of this invention.

FIG. 5a illustrates the implementation of the light modulator elements of the near-eye display system that matches the angular acuity and FOV of the viewer's HVS.

FIG. 5b illustrates the implementation of the optical elements of the near-eye display system of this invention.

FIG. 6a illustrates a multi-focal planes embodiment of this near-eye light field display of this invention.

FIG. 6b illustrates an embodiment of this invention that implements multi-focal planes near-eye display using canonical Horopter surfaces.

FIG. 7 illustrates the generation of content for the multi-focal planes near-eye light field display of this invention.

FIG. 8 illustrates an embodiment that implements the multi-focal planes depth filtering methods of this invention.

FIG. 9 illustrates an embodiment that implements compressed rendering of light field data input to the multi-focal planes near-eye light field display of this invention.

### DETAILED DESCRIPTION OF THE PREFERRED EMBODIMENTS

References in the following detailed description of the present invention to “one embodiment” or “an embodiment” means that a particular feature, structure, or characteristics described in connection with the embodiment is included in at least one embodiment of the invention. The appearances of the phrase “in one embodiment” in various places in this detailed description are not necessarily all referring to the same embodiment.

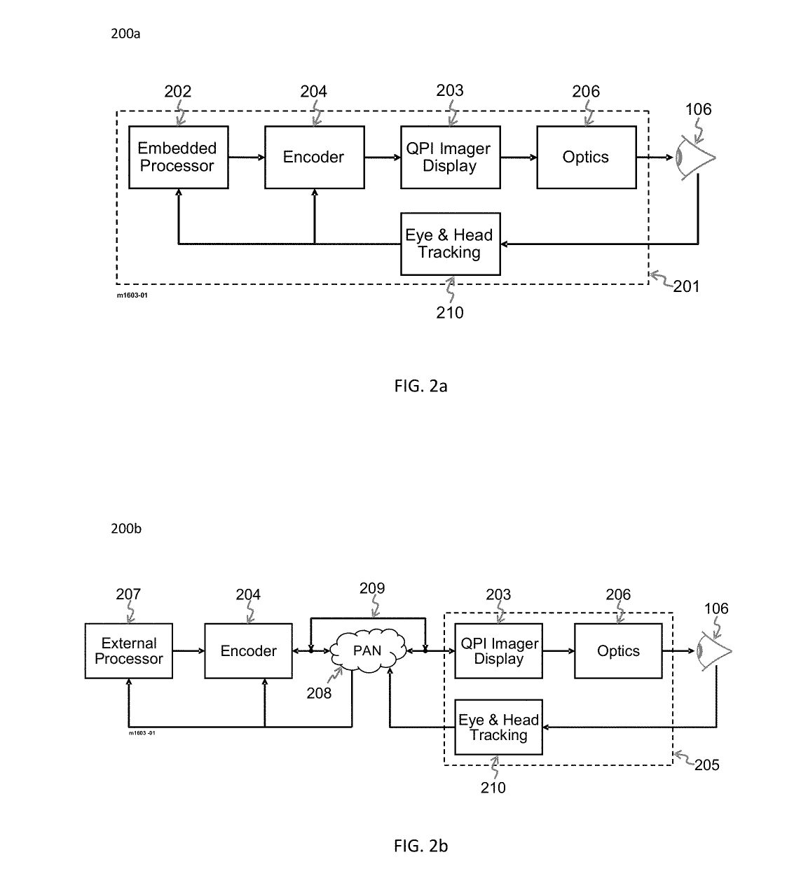

Presenting the viewer of the near-eye display with a high resolution and wide field of view (FOV) 3D viewing experience requires display resolutions that approach the eye viewing limits of eight mega pixels per eye. The resultant increase in display resolution imposes several requirements for a near-eye display system as a whole, the most challenging of which is the increased data interface bandwidth and processing throughput. This invention introduces methods for dealing with both of these challenges in near-eye display systems through the use of Compressed Display systems (as defined below). FIGS. 2a and 2b are block diagram illustrations of the near-eye display system 200 that use the methods of this invention. In FIG. 2a, which illustrates one embodiment of the near-eye assembly 201 of the near-eye display system 200, a new design element, the encoder 204, is added to the near-eye display system 200, which is responsible for compressing the data for a compressed display 203, such as the QPI solid state imager based display (QPI Imager Display in the drawings), for example (U.S. Pat. Nos. 7,767,479 and 7,829,902). In addition to QPI imagers wherein each pixel emits light from a stack of different color solid state LEDs or laser emitters, imagers are also known that emit light from different color solid state LEDs or laser emitters that are disposed in a side by side arrangement with multiple solid state LEDs or laser emitters serving a single pixel. Such devices of the present invention will be referred to generally as emissive display devices. Further, the present invention can be used to create light sources for many types of Spatial Light Modulators (SLMs, micro-displays) such as DLPs and LCOS and also can be used as a Backlight Source for LCDs as well. Herein the term solid state imager display, display element, display and similar terms will be used herein to frequently refer to the compressed display 203. In FIG. 2b, which illustrates another embodiment of the near-eye assembly 205 of the near-eye display system 200, the encoder 204 fulfills the same function as that in FIG. 2a but as part of an external data source remotely driving the near-eye assembly 205. FIG. 2b shows the external data source as comprising an external processor 207 and the encoder 204 with the latter being connected to the near-eye display assembly 205 via a wireless link 208, such as wireless Personal Area Network (PAN), or via a wire 209. In both cases, the encoder 204 leverages the compressed processing capability of the solid state imager display 203, in order to achieve high compression ratios while generating a high-quality image. The encoders 204 also utilize sensory data provided by the eye and head tracking design element 210 to further increase the data compression gain of the near-eye display system 200.

### Definitions

“Compressed (Input) Display” is a display system, sub-system or element that is capable of directly displaying the content images of provided compressed data input directly in a compressed format without first decompressing the input data. Such a compressed display is capable of modulating images at high sub-frame rates in reference to high order basis for direct perception by the human visual system (HVS). Such display capability, termed “Visual Decompression” as defined below allows a compressed display to modulate high order macros comprising (n×n) pixels using the expansion coefficients of Discrete Cosine Transform (DCT) or Discrete Walsh Transforms (DWT) directly for the HVS to integrate and perceive as a decompressed image. (U.S. Pat. No. 8,970,646)

“Dynamic Gamut”—Compressed display system may also include a capability known as Dynamic Gamut (U.S. Pat. No. 9,524,682) in which the display system is capable of dynamically adjusting its color gamut on frame-by-frame basis using word length adjusted (compressed) color gamut data provided within the frame header. In using the Dynamic Gamut capability, the compressed display system processes and modulates input data into corresponding images using a compressed color gamut that matches the color gamut of the input frame image as well as the HVS acuity. Both of the Visual Decompression and Dynamic Gamut capabilities compressed display reduce interface bandwidth and processing throughput at the display side since the input data does not need to be decompressed and both capabilities are supported by compressed displays such as solid state imager displays, for example.

“Visual Decompression” are a multiplicity of compressed visual information modulation methods that leverage the intrinsic perceptional capabilities of the HVS in order to enable the modulation of the compressed visual information directly by the display rather than first decompressing then displaying the decompressed visual information. Visual Decompression reduces the interface bandwidth to the display and the processing throughput required to decompress compressed visual information.

Visual Decompression—

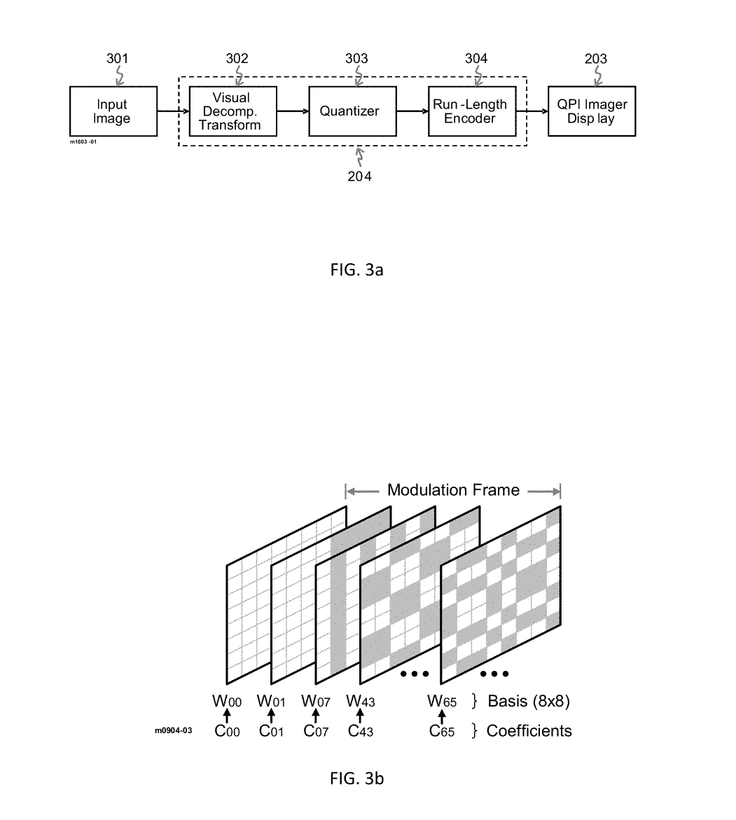

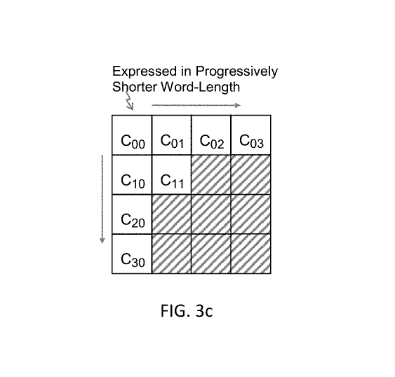

FIG. 3a illustrates a functional block diagram of the encoder 204 (of FIG. 3a and FIG. 3b) that applies the Visual Decompression capabilities of the compressed display 203 within the context of the near-eye display systems 200 of this invention. The input image 301, generated by the processor 202 or 207, is first transformed by the Visual Decompression Transform element 302 into a known high order basis, such as DCT or DWT basis, for example. A selected subset of the resultant coefficients of these high order basis are then quantized by the Quantizer 303. Similar to typical compression schemes that use DCT and DWT, such as MPEG and JPEG, the Visual Decompression applied by the encoder 204 of the near-eye display systems 200 of this invention achieves compression gain in part by selecting the subset of basis having low frequency while truncating the high frequency basis. In one embodiment of this invention, the quantizer 303 uses the same quantization step size for quantizing the selected subset of basis coefficients. In another embodiment of this invention, the quantizer 303 leverages the capabilities of the human visual system (HVS) and uses a larger quantization step for high frequency coefficients in order to reduce the data transfer bandwidth associated the coefficients that are less perceptible by the HVS, thus in effect achieving a higher Visual Decompression gain by matching the HVS capabilities. The quantized coefficients are then temporally (or time division) multiplexed by the Run-Length Encoder 304, which sends the set of coefficients associated with one of the selected basis at a time to the Visual Decompression capable compressed display 203 which would then modulate the coefficients it receives as the magnitude of the associated basis macros it displays. The compressed display 203 would modulate one of the basis at a time within one video sub-frame such that the modulated basis are not temporally separated by more than the time constant of the HVS impulse response, which is typically ˜5 ms. For example, if 8 basis are selected to transform input image 302, then a 60 Hz (16.67 ms) video frame would be partitioned into ˜2 ms sub-frames, which is well below the time constant of the HVS impulse response, during each of which one basis coefficient would be modulated by the compressed display 203.

In another embodiment, the Visual Decompression Transform block 302 extracts the DWT and DCT coefficients directly from the externally provided compressed input data format, such as MPEG and JPEG data format, then provide the extracted DWT and DCT coefficients to the quantizer 303. In this case, the quantizer 303 would further augment the DWT and DCT coefficients of the MPEG and JPEG data format by using a larger quantization step for high frequency coefficients in order to reduce the data transfer bandwidth associated the coefficients that are less perceptible by the HVS, again in order to achieve a higher Visual Decompression gain by matching the HVS capabilities.

In another embodiment of this invention, the basis coefficients of the transformed 302 and quantized 303 input image 301 are field sequenced 304 directly to a compressed display 203 that is capable of modulating the visually compressed data directly to the HVS (see prior definition of compressed display). In addition to reducing the memory requirements at the display 203 due to the Visual Decompression gain it achieves, this method of direct transfer and modulation of compressed image data also reduces the latency in transferring image data from the processor 202 or 207 to the display 203 and forward to the HVS 106. Reducing such latency in near-eye display systems is very important in order to reduce the viewers' discomfort that is typically caused by excessive input image 301 delays relative to the viewer gaze direction detected by the eye & head tracking sensors 210. The latency is reduced because in this method of direct transfer and modulation of compressed image data the subsets of basis coefficients are modulated by the display 203 time sequentially to the HVS 106 as it is received at a sub-frame temporal sequence that is typically shorter than HVS time constant, which allows the HVS 106 to begin integrating them partially and gradually perceiving the image input 301 within few of the sub-frames of the modulated basis coefficients, thus substantially reducing the feedback delay in incorporating gaze direction information sensed by the eye & head tracking 210 into the input image 301. The latency is also reduced in this method of direct transfer and modulation of compressed image data because the compressed input image 301, as represented by the selected basis coefficients generated by the encoder 204, is displayed directly to the HVS 106 without the processing delay typically introduced by prior art systems that first compress the input image 301 data at the processor 102 or 107 side then decompress it at the display 203 side. In addition to reducing the near-eye display system latency, the described near-eye Visual Decompression methods of direct transfer and modulation of compressed image data of this invention would also substantially reduce the processing, memory and power consumption requirements of the near-eye system as it eliminates the processing related to compression of the input image 301 data at either processor 102 or 107 side and the decompression at the display 203 side. It is worth mentioning that the described near-eye Visual Decompression methods of direct transfer and modulation of compressed image data of this invention achieve reduced latency and processing requirements because it make use of the intrinsic capabilities of the HVS 106 of perception through visual sensory temporal integration. That is to say the described near-eye Visual Decompression methods of direct transfer and modulation of compressed image data of this invention achieve reduced latency and processing requirements by matching the capabilities of the HVS.

FIG. 3b illustrates the basis coefficients modulation of the Visual Decompression methods of the near-eye display system of this invention. Instead of the row/column select method typically used in current displays for addressing (and modulating) individual display pixels, in the near-eye Visual Decompression method illustrated in FIG. 3b, the display modulates groups of (n×n) pixels representing the high order basis Wᵢⱼ together with the same basis coefficient value Cᵢⱼ. Within a sub-frame of the video input image 301, the near-eye compressed display 203 would address the blocks of (n×n) pixels as a macro representing the display basis element Wᵢⱼ with the associated basis coefficients Cᵢⱼ. The temporal sequence of the basis coefficients modulation sub-frames within a video frame would be time sequentially integrated by the HVS leading to gradual perception the input image 301 within the time period of that video frame. As can be seen from FIG. 3b, the near-eye compressed display 203 would have to possess the response time and modulation capabilities to receive and modulate basis coefficients at the sub-frame rate, which would be multiple times faster than the video frame rate, for the example described earlier when having eight sub-frames, the Visual Decompression sub-frame rate would be 8×60 Hz=480 Hz. In one embodiment of this invention, the near-eye compressed display 203 is realized using a solid state imager because of their high-speed image modulation capability. In addition to a solid state imager's capabilities to support the Visual Decompression methods of this invention, the near-eye display system 200 of this invention would also benefit from the small size (compactness), low power consumption and brightness offered by the QPI 203 in order to realize a volumetrically streamlined near-eye display system 200.

Referring back to FIG. 3a, the quantizer 303 would truncate the basis coefficients computed by the Visual Decompression transform element 302 based on a given truncation criterion then quantize the selected subset of basis coefficients into a given word length based on a given quantization criterion. FIG. 3c illustrates the basis coefficients truncation performed by the quantizer 303 for a (4×4) Visual Decompression basis. As illustrated in FIG. 3c, the quantizer 303 would truncate the set of 16 basis coefficients by selecting the subset of eight basis coefficients marked in FIG. 3c. The criterion for this selection would be to discard the high frequency basis coefficients that are beyond the HVS temporal acuity limits, the higher index basis crosshatched in FIG. 3c. For the selected subset of basis coefficients, the quantizer 303 then truncates their corresponding word length received from the Visual Decompression Transform 302 to a fewer number of bits, for example 8-bit word. It should be noted that the Visual Decompression Transform 302 would typically perform the transform computation at higher word length, for example 16-bit word. In another embodiment, the quantizer 303 truncates the selected subset of basis coefficients using different word lengths for different basis coefficients. For example, in referring to FIG. 3c, the low frequency coefficient C₀₀ would be quantized into 8-bits while the remaining basis coefficients along the row coefficients C₀ⱼ and column coefficients Cᵢₒ would be quantized using successively lower word lengths, for example 6-bit, 4-bit and 2-bit; respectively. Both of the basis coefficients truncation and their word length quantization criteria would be either fixed and known a priori by the display 203 or signaled (communicated) through the data stream to the display 203 embedded. The data transfer bandwidth compression gain expected to be achieved by the near-eye Visual Decompression method of this embodiment would typically be dependent upon the dimensionality of the basis used to transform the input image 301 and the basis coefficient truncation criteria used by the quantizer 303, but would typically range from 4× to 6×, meaning that the image data transfer bandwidth from the processor 102 or 107 to the display element 203 would be reduced by a factor ranging from of 4× to 6× by the described Visual Decompression methods of this embodiment. It should be noted that the visual compression gain of this embodiment is achieved by making the display matches the temporal acuity of the HVS.

Dynamic Gamut—

In another embodiment of this invention, the near-eye display system 200 takes advantage of the following two factors that offer additional visual decompression opportunities: (1) the color gamut of a video frame is typically much smaller than the preset standard display gamut, for example NTSC, in which the display pixels color coordinates within that standard color gamut is typically expressed in 24-bit word with 8-bit per color primary; and (2) the color acuity of the HVS peripheral regions is substantially reduced in comparison to the visual central region. In this embodiment, the Visual Decompression Transform block 302 would receive within each input video frame header the color coordinates of the frame color gamut primaries together with the color coordinates of each pixel in the frame expressed relative to the frame color gamut primaries conveyed in the frame header and passes the received frame header forward to the quantizer 303. The Visual Decompression Transform block 302 then passes the frame gamut header it receives along with the set of high order basis coefficients it extracts to the quantizer block 303. The quantizer block 303 would then take advantage of the reduced size of the image frame color gamut by proportionally truncating the word length expressing the color coordinate of each pixel within that image frame to less than the default 24-bit (8-bit per color), the smaller the conveyed frame gamut size relative to the display standard gamut size, the smaller than the default 24-bit word length can be used to express the color coordinate of each pixel within each received image frame. It is also possible that the Visual Decompression block 302 would receive within each input video frame header the color gamut and coordinates of multiple image regions within the image frame together with the color coordinates of each pixel within each of the frame image regions expressed relative to the color gamut primaries conveyed in the frame header for that frame image region. In this case, the quantizer block 303 would proportionally truncate the word length expressing the color coordinate of each pixel within each the frame image regions to less than the default 24-bit (8-bit per color). In typical video frame images, either of the two methods described could lead to a factor of 2× to 3× reduction in the size of the image frame data that needs to be forwarded to the compressed display 203 with the latter method achieving a compression factor closer to the higher end of that range. When the frame, or frame image regions, color gamut is received by the compressed display 203, which as defined earlier has the capability to dynamically adjust its color gamut, the compressed display 203 will use the frame or frame region color gamut coordinates data conveyed in the received header to synthesize the conveyed frame or frame sub-region color gamut using its native color primaries then will modulate the received (truncated) frame or frame sub-region pixels color coordinates data to modulate the light is generates representing each of the frame or frame sub-region pixels. It should be noted that the visual compression gain of this embodiment is achieved by making the display color gamut match the image frame color gamut.

Foveated Visual Decompression—

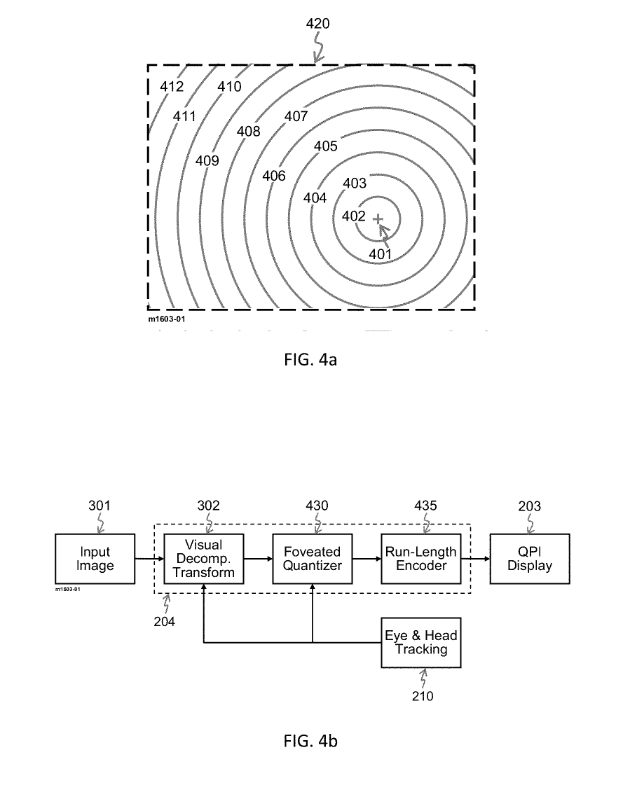

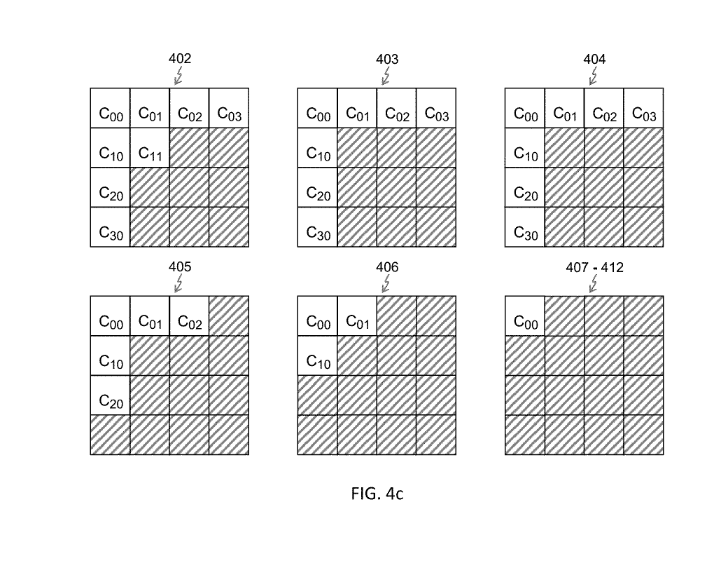

FIGS. 4a and 4b illustrate yet another Visual Decompression method of the near-eye display system 200. In this embodiment, illustrated in 4(a) and 4(b), the viewer's gaze direction (axis) 401 and the focus distance, based on the viewer's Inter-Pupillary Distance (IPD), are sensed and tracked by the eye and head tracking element 210 then used to apply different Visual Decompression basis coefficients truncation and quantization criteria to different regions of the image displayed within the viewer's field of view (FOV) 420 in order to effectively enable the highest possible visual perception within the FOV region where the viewer's eyes are focused 402 while taking advantage of the HVS angular (acuity) distribution of visual perception to achieve high level of visual compression systematically across the remaining regions of the viewer's FOV 403-412 where the HVS visual acuity gradually decreases. In effect in this embodiment Visual Decompression would be applied in a way that matches the angular distribution of the HVS acuity using compression word-length that is proportional to the angular distribution of the viewer's visual perception across the FOV.

FIG. 4a illustrates the methods of this embodiment of Visual Decompression, hereby referred to as “Foveated Visual Decompression”, which leverages the fact that the viewer's spatial (angular) acuity is the highest in the region where the viewer's eyes are focused 402 (fovea region of the retina) and systematically reduces across the rest of the viewer's FOV 403-412 (parafovea 403-406 and perifovea regions 407-412 of the retina) in order to achieve even higher Visual Decompression gain while enabling the highest visual perception capability in the region where the viewer is focused 402. In this embodiment, the viewer's eyes' focus and gaze direction 401 cues would be extracted by the Foveated Quantizer 430 of FIG. 4b from the sensory data provided by the eye and head tracking element 210 sensor, for example the gaze direction for each eye would be determined by the position of the each eye pupil within the head direction frame of reference as detected by the eye and head tracking element 210 sensor. Similarly the near-eye display system viewer's focus distance (or vergence distance, which is defined as the distance at which both of the viewer's eyes are focused and converged) would be determined by the relative Inter-Pupillary Distance (IPD) between the centers of the viewer's two pupils as detected by the eye and head tracking element 210 sensor. For the region of the FOV 420 where the viewer is focused 402, which typically covers the fovea region of the retina when focused by the viewer's eye lens, the highest image resolution would be achieved by having the Foveated Quantizer 430 select as large as possible subset of the basis coefficients and use the largest possible word length to quantize this selected subset of basis coefficients. For the remaining region of the viewer's FOV 420, regions 403-412 in FIG. 4a, the Foveated Quantizer 430 would select subsets of fewer basis coefficients and would also use fewer number of bits to quantize the selected basis coefficients. In applying such basis coefficient truncation and quantization criteria, the Foveated Visual Decompression method of this embodiment would achieve the highest resolution within the viewer's region of focus 402 and systematically lesser resolution across the remaining region 403-412 of the viewer's FOV 420 without degrading the viewer's perception while achieving even higher Visual Decompression gain across these FOV regions. It should be noted that the term “foveated” is used within the context of this embodiment is meant to indicate that the display resolution would be adapted to the HVS acuity profile (distribution) from the center of the viewer's eyes fovea outward toward the peripheral region of the viewer's eyes retina. Such a viewer's gaze direction dependent image resolution is known in the prior art as “foveated rendering”, an example of which is described in Guenter, B., Finch, M., Drucker, S., Tan, D., and Snyder, J., “Foveated 3D Graphics”, ACM SIGGRAPH ASIA, November, 2012, which typically foveates the image input 301 through image rendering to possibly reduce the image rendering computational load at the processor 102 or 107, however that benefit does not directly translate into the reduction in the image interface 301 bandwidth and the decompression computational load at the display 203 that could be achieved by the described Foveated Visual Decompression methods of this embodiment.

FIG. 4b illustrates a block diagram of the near-eye display system that uses the Foveated Visual Decompression methods of this invention. Referring to FIG. 4b, with the knowledge of the viewer's focal point based on the input provided by the eye and head tracking element 210, the Foveated Quantizer 430, following the Visual Decompression transform 302, would select basis truncation and quantization to be adapted such that the displayed image area that corresponding to the viewer's focus region 402 (the image region that would be focused by the eye onto the fovea region of the viewer's retina) has the highest spatial resolution while the remaining region 403-412 of the viewer's FOV 420 has systematically lesser resolution consistent (or proportional) with the angular (spatial) acuity gradation of the viewer's eye across the parafovea and perifova of the viewer's retina. FIG. 4c illustrates an example of the Foveated Quantizer's 430 basis truncation and quantization selection in accordance with Foveated Visual Decompression methods of this invention. FIG. 4c illustrates an example of the basis coefficients truncation performed by the Foveated Quantizer 430 for a (4×4) Foveated Visual Decompression basis. As illustrated in the example of FIG. 4c, the Foveated Quantizer 430 would truncate the set of 16 basis coefficients by selecting the largest subset of eight basis coefficients marked in the first panel of FIG. 4c as corresponding to the viewer's focus region 402. For that region (402) the Foveated Quantizer 430 would also use the highest quantization word length, for example 8-bit per color, to represent the basis coefficients selected for region 402 of the viewer's FOV. As illustrated in FIG. 4c, for the peripheral focal region 403 the Foveated Quantizer 430 would truncate the set of 16 basis coefficients into the fewer subset of seven basis coefficients marked accordingly in FIG. 4c. For that region the Foveated Quantizer 430 may also select a shorter word length, for example 7-bit or 6-bit, to represent the basis coefficients selected for region 403 of the viewer's FOV. As illustrated in FIG. 4c, for the outer peripheral regions 404-412 the Foveated Quantizer 430 would truncate the set of 16 basis coefficients into systematically fewer subset of basis coefficients as marked accordingly in FIG. 4c and may also select a shorter word length, for example fewer than 6-bit, to represent the basis coefficients selected for region 403 of the viewer's FOV.

Referring back to FIG. 4b, the truncated and quantized basis coefficients generated by the Foveated Quantizer 430 for the multiplicity of FOV 200 regions are then further encoded by the Run-Length Encoder 435 which embed control data packets (or data headers) within the encoded data stream that signal (or specify) which basis coefficient are included in the streamed data and its truncation and quantization word length. For example, within the data field designated for sending the basis coefficient value Cᵢⱼ the Run-Length Encoder 435 will append a header that includes a data field that specifies whether the basis coefficient value Cᵢⱼ is included and its associated quantization word length. The appended basis coefficient will then be sent as time division multiplexed set of coefficients for one of the selected basis at a time to the compressed display 203 which would then decodes the control header appended by Run-Length Encoder 435 then accordingly modulates the coefficients it receives as the magnitude of the associated basis it displays. Since as illustrated in FIG. 4c the number of basis coefficients associated with the display regions 403-412 are systemically reduced, the displayed image resolution would also be systematically reduced across these regions of the displayed image in proportion with typical HVS acuity distribution. As explained earlier, the criterion for selecting the basis coefficient to be included for each of the display regions 403-412 would be based upon the angular (spatial) acuity of their corresponding retina regions and that criterion will be set as a design parameter of the Foveated Quantizer 430.

The data transfer bandwidth compression gain expected to be achieved by the near-eye Foveated Visual Decompression methods of this invention would typically be dependent upon the dimensionality of the basis used to transform the input image 301 and the basis coefficient truncation and quantization criteria used by the Foveated Quantizer 430 but would typically exceed that of the Visual Decompression methods described earlier. In knowing that once the eye is focused, the displayed image region 402 would nominally span the angular extent of the fovea region (about 2°) of the viewer's eye, when the near-eye-display system 200 has a total FOV of 20°, for example, the Foveated Visual Decompression methods of this invention would achieve a compression gain ranging from 4× to 6× in the displayed image region 402 and systematically higher compression gain across the displayed image regions 403-412. In using the example of basis coefficient truncation illustrated in FIG. 4c, the achieved compression gain would increase by a factor 8/7 for the regions 403 and 404, then by factors of 8/5, and 8/3 for the regions 405 and 406; respectively, then by a factor of 8 for the peripheral regions 407-412. In taking into account the area of each of the image regions 401-412 relative to the displayed image FOV and the overhead due to the control data appended by the Run-Length Encoder 435, the composite compression gain that can be achieved by the Foveated Visual Decompression methods of this invention for the foveated basis coefficients truncation example of FIG. 4c would be in the range from 24× to 36×, meaning that the image data transfer bandwidth from the processor 102 or 107 to the display element 203 would be reduced by a factor ranging from of 24× to 36× by the Foveated Visual Decompression methods of this invention. It should be noted that an when the FOV of the near-eye-display system 400 of the previous example is greater than the 20°, for example 40°, the achieved compression gain for the peripheral regions 407-412 would asymptotically approach a factor of eight times higher than the compression gain achieved in the image central regions 402-406. Since for large display FOV the peripheral image regions would constitute the majority of the displayed FOV, the Foveated Visual Decompression methods of this invention would be able to achieve even higher composite compression gain (approaching a factor higher than 40×) when the near-eye-display system 200 has a FOV that approaches that of the HVS (it is known that the HVS FOV is greater than 100°).

In another embodiment of the Foveated Visual Decompression methods of this invention, the Visual Decompression Transform 302 uses different values of the high order basis for the image regions corresponding to the eye's fovea 402, parafovea 403-406 and perifovea 407-412 regions of the retina in order to achieve an even higher compression gain. In this embodiment, the Visual Decompression Transform 302 receives the eye gaze point (direction) 401 input from the eye and head tracking element 210, then identifies the image regions corresponding to the fovea region 402, the parafovea regions 403-406 and the perifovea regions 407-412, then uses different values of the high basis in order to create the transformed version for each image region. For example, the Visual Decompression Transform 302 would use (4×4) basis to create the transformed version for image regions 402-406 and use (8×8) basis to create the transformed version of image peripheral regions 407-412. The Visual Decompression Transform 302 would then stitch the transformed images of the multiple regions together before sending the composite transformed image together with embedded control data identifying the basis order used for each image region to the Foveated Quantizer 430. The Foveated Quantizer 430 would apply the basis coefficients appropriate truncation and quantization criteria to each image region then sends the image and corresponding control data forward to run-length encoder 304 for transmission to the compressed display 203. With the use of higher order basis in the image region corresponding to the fovea peripheral regions, the Foveated Visual Decompression methods of this embodiment will be able to achieve an even higher compression gain. For the previously discussed example, when (4×4) basis are used for the image regions 402-406 and (8×8) are used for image peripheral regions 407-412, Foveated Visual Decompression methods of this embodiment will be able to achieve a compression gain that would asymptotically approach the factor of 16× higher than the compression gain achieved in the image central regions 402-406. Thus the Foveated Visual Decompression methods of this embodiment would be able to achieve a composite compression gain ranging from 32× to 48× for the previous example of display FOV of 20° and possibly reaching 64× for display FOV of 40°.

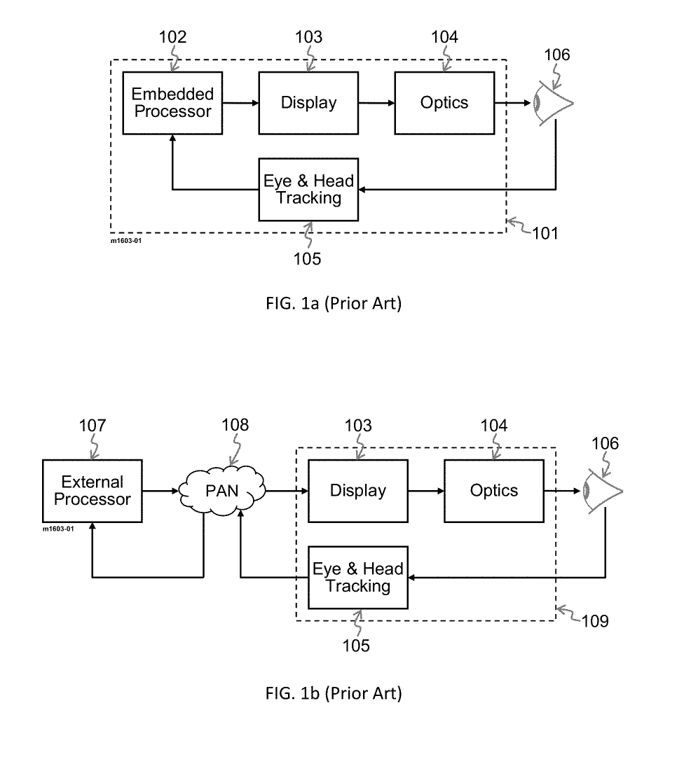

The described levels of compression gain that can be achieved by the Foveated Visual Decompression methods of this invention would translate directly into processing and memory reduction at the display 203 side, which would directly translate into reduction in the power consumption, volumetric aspects and cost. It should be noted that the processing and memory requirements of the Visual Decompression block 302 and the Foveated Quantizer 430 blocks of FIG. 4c would be comparable to those of a conventional image decompression element except that the latter expands the image data bandwidth thus causing a significant increase in the processing and memory requirements at the display 203 side with a proportional increase in power consumption. Furthermore, the processing and memory requirements of the Visual Decompression 302 and the Foveated Quantizer 430 blocks of FIG. 4c would be comparable to those of a prior art foveated rendering block, thus near-eye display system 200 that uses the Foveated Visual Decompression methods of this invention would require significantly less processing and memory (thus reduced cost and power consumption) than the prior art near-eye display systems of FIG. 1a and FIG. 1b that incorporate prior art foveated rendering and uses conventional compression techniques. It should also be noted that the Foveated Visual Decompression methods of this invention attains that gain by matching the intrinsic capabilities of the HVS; namely, the temporal integration and graded (or foveated) spatial (angular) resolution (acuity) of the HVS. It is also important to note that the level of compression gain that can be achieved by the Foveated Visual Decompression methods of this invention would be paramount when the near-eye display system 200 is required to display a multi-view or multi-focal light field since the processing, memory and interface bandwidth of such systems is directly proportional to the number of views or the number of focal planes (surfaces) it is required to display—which for a well-designed near-eye display system can range from six to 12 views that need to be displayed to achieve acceptable 3D perceptional levels by the near-eye display viewer.

Foveated Dynamic Gamut—

In another aspect of the previous Dynamic Gamut embodiment the Visual Decompression block 302 would receive, from the eye and head tracking element 210, information pertaining to the viewer's gaze direction which it will then map into the corresponding pixel (macro) spatial coordinate within the image frame that identifies the center of the viewer's field of view and append that information with the image frame data it passes to the quantizer block 303. Using the identified spatial coordinates of the center of the viewer's field of view, the quantizer block 303 will then apply the typical HVS (angular or directional) color acuity profile to proportionally truncate the default 24-bit (8-bit per color) word length of the image pixels (or macro) color coordinates into smaller size (in bits) word length depending on the position of each pixels (or macro) relative to the spatial coordinates of the center of the viewer's field of view identified for that frame. The typical HVS (angular or directional) color acuity profile (distribution) would be maintained by the quantizer block 303 as a look-up table (LUT) or a generating function that identifies the pixel (or macro) color coordinates word length quantization factor depending on the pixel's (or macro's) spatial distance from the center of the viewer's field of view. Such HVS color acuity profile LUT or generating function would be based on the typical viewer's (angular or directional) HVS color acuity profile and could be adjusted, or biased by a given factor, depending on each specific viewer's preference. The color gamut distribution corresponding to the HVS color acuity profile would then be appended to the pixels (or macros) quantized color values by the run-length encoder 304 before being sent to the display element 203 for modulation. The described methods of pixels' (or macros) color coordinates word length truncation based on the angular or directional color acuity profile around the identified center of the viewer's field of view for each frame is in effect a color foveation of the displayed image that could lead to a factor of 2× to 3× reduction in the size of the image frame data that would be forward to the display 203. Being a compressed display, the display 203 will directly use the pixels' (or macro) truncated color coordinates it receives to modulate the image frame. The term “foveated” used within the context of this embodiment is meant to indicate that the display color gamut would be adapted to the HVS color acuity profile (distribution) from the center of the viewer's eyes fovea outward toward the peripheral region of the viewer's eyes retina. It should be noted that the visual compression gain of this embodiment is achieved by making the display matches the color perception acuity distribution of the HVS.

Near-Eye Light Field Display—

When a different perspective of a scene image or video information is transmitted to each eye, the viewer's HVS would be able to fuse both images and perceive the depth conveyed by the difference (disparity) between the right and left images or video frames (3D perception); an ability that is known as stereoscopic depth perception. However, in conventional 3D displays, which typically use 2-views, one view for each eye, the depth perceived by the viewer may be different from the depth on which the viewer's eyes are focusing. This leads to a conflict between the convergence and accommodation depth cues provided to the viewer's HVS (an effect known as the Vergence-Accommodation Conflict, VAC), and can lead to viewer's headaches, discomfort and eyestrain. VAC can be eliminated by providing each of the viewer's eyes with a commensurate perspective of the entire light field in order to enable the viewer's HVS to naturally accommodate and converge at the same point within the light field; i.e., a focusable light field. The perspectives of the light field presented to each of the viewer' eyes can either be angular or depth samples (or slices) of the light field. When the perspectives presented to each of the viewer's eyes are angular samples of the light field, the approach is referred to as multi-view light field and when depth samples are used it is referred to as multi-focal planes light field. Although their implementation details could be different, the two approaches of presenting a VAC-free light field to the viewer's HVS are functionally equivalent representation of the light field. In either approaches the bandwidth of the visual data being presented to the viewer's HVS would be proportional to the number of light field samples (views or focal planes) being used to represent the light field perspectives and as such would be much higher than the conventional stereoscopic method that present one view (or perspective) per eye. The increase in the visual data bandwidth would result in a commensurate increase in the processing, memory, power and volumetric aspects of the near-eye display system, which would make it even more difficult to realize a near-eye display that makes use of the light field principals in order to eliminate VAC. The following paragraphs apply the described Visual Decompression methods plus other HVS acuity matching methods in order to make it possible to realize a near-eye display that makes use of the light field principals in order to eliminate VAC and provide its viewer with a high quality visual experience while achieving the compactness (streamlined look) sought after for a practical near-eye, either AR or VR, display system.

Near-Eye Light Field Modulator—

In one embodiment of this invention, the visual information representing the light field samples (views or focal planes) are presented (or modulated by the near-eye display system) to the viewer's HVS using groups of multiple physical pixels of the display (or light modulator) right side and left side element 203R and 203L; respectively, of the near-eye display 200. Herein such a group multiple physical (m×m) pixels of the light modulator element 203R and 203L are together referred to as “(m×m) modulation group” or “macro pixels”. Abbreviated, the individual physical (individual) pixels of the light modulator element 203R and 203L will be referred to as a micro pixel (or m-pixel) and the macro pixels used to modulate the light field samples (views or planes) will be referred as M-pixels. In the case of a multi-view light field near-eye display system implementation the individual m-pixels comprising each of the M-pixels would be used to modulate (or display) the multiple views of the light field being presented to the viewer's HVS and in case of a multi-focal surfaces (planes) light field implementation the M-pixels would be used to modulate (or display) the multiple depth virtual image surfaces that represent the depth planes (samples) of the light field being presented to the viewer's HVS. The dimensionality of the M-pixel will be expressed as (m×m) m-pixels and would represent the total number of light-field samples the near-eye display system would present to each of the viewer's eyes. In this embodiment the optical (light emission) characteristics of the light modulator element 203R and 203L of the near-eye light field display 200 would be made to match the angular acuity and FOV of the viewer's HVS. Since the HVS angular acuity is at its highest level at the viewer's eye fovea region 402 and reduces systematically toward the peripheral regions 403-412 of the viewer's eye retina, it follows that the viewer's HVS depth perception is at its highest level at the viewer's eye fovea region 402 and reduces systematically toward the peripheral regions 403-412 of the viewer's eye retina. Thus, by matching the viewer's HVS angular acuity, the light modulator element 203R and 203L of the near-eye light field display 200 of this embodiment would be made to match, as explained in the following paragraph, the angular depth acuity of the viewer's HVS.

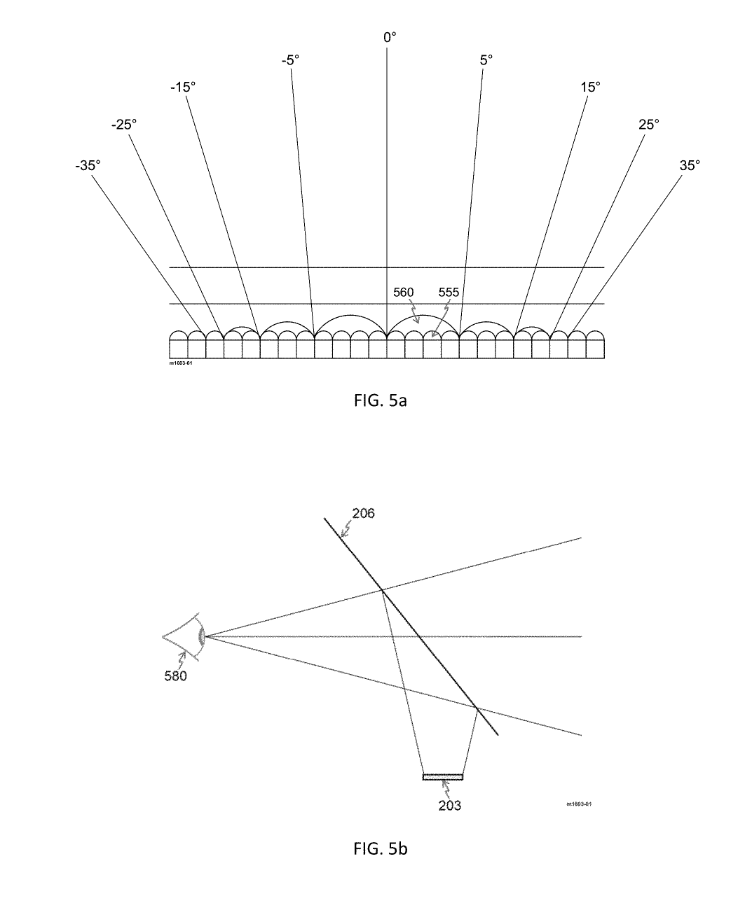

FIG. 5a illustrates the implementation of the light modulator (display) element 203R and 203L of the near-eye display system that would be used to match the angular acuity and FOV of the viewers HVS. In FIG. 5a the m-pixels 550 of the light modulator element 203R and 203L are emissive multi-color photonic micro-scale pixels (typically 5-10 micron in size) comprising the micro optical element 555 that directs the collimated light bundle emitted from the m-pixel onto a given direction (or directionally modulated) within the light modulator element 203R and 203R emission FOV. In addition, associated with each of the M-pixels of the light modulator element 203 illustrated in FIG. 5a is a macro optical element 560 that would fill in (or evenly distributes) the light emitted from its associated m-pixels onto the M-pixel FOV in order to achieve a given angular density of the directionally modulated light bundle emitted from its associated m-pixels modulation group. The collimated and directionally modulated light bundle emitted from each m-pixel will be referred herein to as a “light field anglet”. As illustrated in FIG. 5a, the M-pixels dimensionality would be at its highest level at the optical center of the light modulator element 203R and 203L optical aperture and gradually reduces in proportion with the HVS depth perception acuity away from the image modulation region corresponding with the foveal center. Also as illustrated in FIG. 5a, the M-pixels angular coverage (or FOV) would be the narrowest value at the optical center of the light modulator (display) element 203R and 203L optical aperture and would gradually increase in inverse proportion with decrease in the HVS angular acuity away from the image modulation region corresponding with the foveal center. As a result, the angular density of light field anglets would be at its highest value within the central regions of the light modulator (display) element 203R and 203L optical apertures and decreases systematically within their peripheral regions. In effect the optical F/# of each of the light modulator element 203R and 203L illustrated in FIG. 5a would be at its highest value at the central region of their optical aperture and gradually decreasing, in proportion with the HVS acuity distribution, away from the image modulation region corresponding with the foveal center. In effect, therefore, in this embodiment the light emitted from the light modulator elements 203R and 203L would match the HVS acuity distribution in making its highest resolution available within the images region targeting the viewer's HVS acuity highest level at the viewer's eye fovea region 402 and reduces systematically toward the peripheral regions 403-412 of the viewer's eye retina. It should be noted that in order to match the range of the viewer's eye pupils movement from the near field to the far field of the viewer (˜7°), as illustrated in FIG. 5a the highest resolution central region (central ±5° FOV region in FIG. 5a) of the light modulator elements 203R and 203L would be made wide enough to accommodate all possible eye fovea FOV region 402 positions within the range of the viewer's eye movements from the near field to the far field of the viewer. Having described methods for realizing a light field modulator that optically matches the HVS acuity, the following paragraphs describe methods where the HVS optically matched light modulator element 203R and 203L would be used in conjunction with Foveated Visual Decompression methods described earlier to realize a near-eye light field display 200 that uses either multi-view or multi-focal planes light field sampling methods discussed earlier.

Multi-View Light Field—

FIG. 5b illustrates at a high level the coupling between optical element 206 and the light modulator (display) elements 203R and 203L of the previous embodiment. In the near-eye display system 200 optical element 206 design illustration of FIG. 5b, the image modulated by the display element 203R and 203L would be appropriately magnified then relayed by the optical element 206 to the viewer's eyes 580. The optical element 206 can be implemented using reflector and beam-splitter optical assembly, free-form optical wedge or wave guide optics. Although the design details of these optical element 206 design options are different, their common design criteria is to sufficiently magnify and relay the optical output of the light modulator (display) elements 203R and 203L to the viewer's eyes 580. The design criteria of the selected M-pixel (m×m) dimensionality and the effective optical magnification from the light modulator elements 203R and 203L micro and macro optical elements 555 and 560; respectively, through the optical elements 206 would be such that the spot size of the M-pixels located at the central optical region of the light modulator elements 203R and 203L would match the HVS (average) spatial acuity for a virtual image formed (modulated) at the minimum viewing distance (near-field) of the near-eye display system 200 that covers the fovea central regions (402-404 of FIG. 4a). For example, if the minimum viewing distance of the near-eye display system is 30 cm and given that the HVS spatial acuity at that distance is approximately 40 micron, the pitch the M-pixel at the central optical center region of the light modulator elements 203R and 203L would also be 40 micron and if the pitch of the m-pixel of the light modulator elements 203R and 203L is 10 micron, the dimensionality of the M-pixel would be (4×4) m-pixels, which would enable the near-eye light field display system 200 to modulate up to 4×4=16 views to each of the viewer's eye fovea central regions (402-404 of FIG. 4a). In this example, as illustrated in FIG. 5a, the dimensionality of the M-pixel would be gradually reduced to (3×3), (2×2) then (1×1) of m-pixel to systematically present a reduced number of views in the peripheral regions 405-412 of the viewer's FOV. Thus the light modulator elements 203R and 203L of this embodiment would match the viewer's HVS angular acuity and depth perceptional aspects by modulating higher number of views onto the viewer's central fovea regions (402-404 of FIG. 4a) and systematically fewer number views onto the peripheral regions 405-412 of the viewer's FOV. This in effect is a form of visual compression since the highest number of views needed to provide the viewer with highest depth cues are modulated by the light modulator element 203R and 203L within the viewer's central fovea regions (402-404 of FIG. 4a), as indicated by the viewer's gaze direction and focal depth sensed by the eye and head tracking element 210, and systematically fewer number views are modulated onto the peripheral regions 405-412 of the viewer's FOV in proportion with the HVS typical acuity angular distribution. Accordingly in the previous example, 16-views would be modulated by the display elements 203R and 203L onto the viewer's eye fovea central regions (402-404 of FIG. 4a), which is approximately 2° wide, with fewer number of views being modulated onto the peripheral regions 405-412 of the viewer's FOV, thus reducing the image input 301 bandwidth to be mostly proportional with the angular width of viewer's eye fovea central regions (402-404 of FIG. 4a) in proportion to the full angular width of the near-eye display 200 FOV. That is to say, when the near-eye light field display 200 FOV is 20° wide, for example, and 16-view are modulated onto its central 2° wide angular region and an average of 4-views in its peripheral regions, the effective bandwidth of approximately five views would be sufficient in such case, which equates to a compression gain of a factor of 3×. Of course higher compression gains would be achieved with the visual compression method of this embodiment when the near-eye display 200 FOV is wider that the 20° assumed in the illustrative example.

Multi-View Light Field Depth Foveated Visual Decompression—

Because of the systematic decrease of the HVS angular (perceptional) acuity from the central toward the peripheral regions of FOV, the HVS depth perception acuity also decreases systematically from the near-field (˜30 cm) toward the far-field (˜300 cm) of the viewer. It therefore follows that the HVS requires a higher number of views for near-field depth perception than for far-field depth perception. Furthermore, when the viewer's eyes are focused and accommodating at a certain point, the HVS depth perception acuity is at its highest level within the vicinity of that point and reduces systematically with either depth or angular deviations from that point. Thus the views contributing to the visual information within the vicinity of the point where the viewer's eyes are focused and accommodating contribute the most to achieving depth perception, in addition, the number of such views decreases systematically as the viewer's eyes focus changes from the near-field toward the far-field of the viewer. This attribute of the HVS depth perception presents yet another visual compression opportunity that can be leveraged by the combination of the (foveated) multi-view light modulator element 203R and 203L of FIG. 5a and the previously described Foveated Visual Decompression methods. In an embodiment that incorporates within the near-eye light field display system 200 both the multi-view light modulator elements 203R and 203L of FIG. 5a and the Foveated Visual Decompression methods of the previous embodiments, the sensed point of focus of the viewer provided by the eye and head tracking element 210 is used to determine (or identify) the light field views contributing the most visual information within the vicinity of the point where the viewer's eyes are focused and the described Foveated Visual Decompression methods are then applied to proportionally compress the light field views being modulated to the viewer by the multi-view light modulator elements 203R and 203L of FIG. 5a in relation to their contribution to visual information within the vicinity where the viewer's eyes are focused. In effect, therefore, with the methods of this embodiment, the light field views contributing the most visual information within the vicinity of the point where the viewer's eyes are focused would be modulated by the multi-view light modulator elements 203R and 203L of FIG. 5a to achieve the highest visual perception using the highest number of modulation basis coefficients at a minimal truncation of their word-length representation while light field views having lesser contribution within the vicinity of the point where the viewer's eyes are focused would be modulated by the multi-view light modulator element 203R and 203L of FIG. 5a using fewer light field modulation views spaced at a wider angular pitch using the proportionally lesser number of modulation basis coefficients at a higher word-length truncation. The net effect of the methods of this embodiment is a three dimensional Foveated Visual Decompression action in which the visual information within the vicinity of the point where the viewer's eyes are focused would be modulated at the highest fidelity that matches the HVS perceptional acuity at the point of focus of the viewer while the visual information of surrounding regions (front, back and sides regions) are modulated at a fidelity level that matches the proportionally lesser perceptional acuity of the HVS at points away from where the viewer's eyes are focused. The combined methods of this embodiment are referred to collectively as Multi-view Light Field Depth Foveated Visual Decompression. It should be noted that the term “foveated” is used within the context of this embodiment is meant to indicate that the display resolution would be adapted to the HVS depth perception acuity profile (distribution) from the center of the viewer's eyes fovea outward toward the peripheral region of the viewer's eyes retina.

It is further noted that although in the previous embodiments a higher number of views would be modulated by the display elements 203R and 203L onto the viewer's eye fovea central regions (402-404 of FIG. 4a) as indicated by the eye and head tracking element 210, the display elements 203R and 203L would still be able to modulate the highest number of views possible across an angular region that extends across the angular distance between the viewer's near and far fields, which is a total of approximately 7°. Nonetheless, when the Foveated Visual Decompression methods of the previous embodiments are applied, it would truncate and quantize the modulation basis coefficients in a way that matches the HVS angular perceptional acuity, as explained earlier, thus in effect compounding the compression gains of the Foveated Visual Decompression and the foveated multi-view light modulator element 203R and 203L of FIG. 5a. That is to say with the previous examples when the Foveated Visual Decompression that achieves a moderate compression gain factor of 32× is combined with the foveated multi-view light modulator element 203R and 203L of FIG. 5a that achieves a compression gain factor of 3×, the compound compression that can be achieved by the near-eye multi-view light field display system 200 would reach a compression gain factor of 96× in comparison with a near-eye display system that achieves comparable viewing experience and provides 16-views per eye near-eye light field display capability.

Multi-Focal Planes (Surfaces) Light Field—

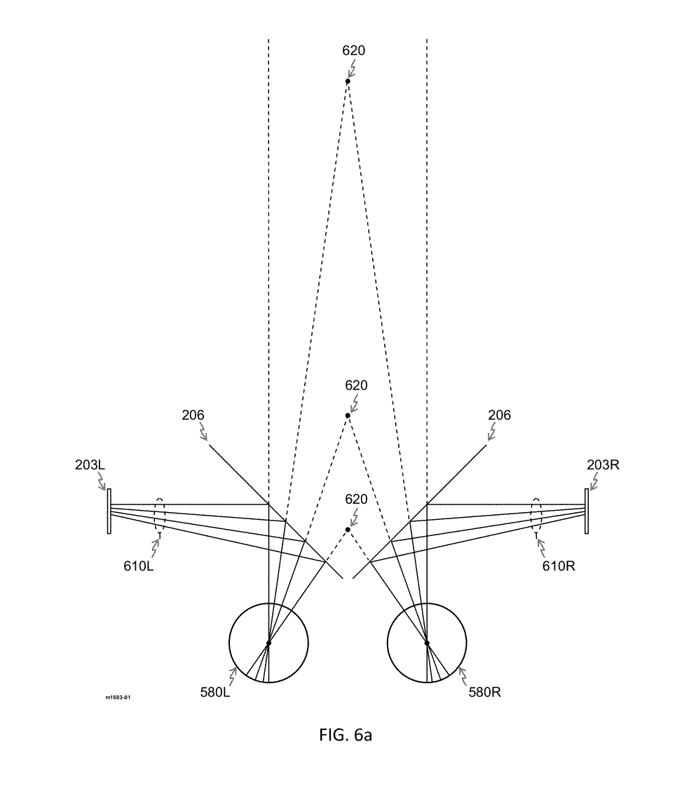

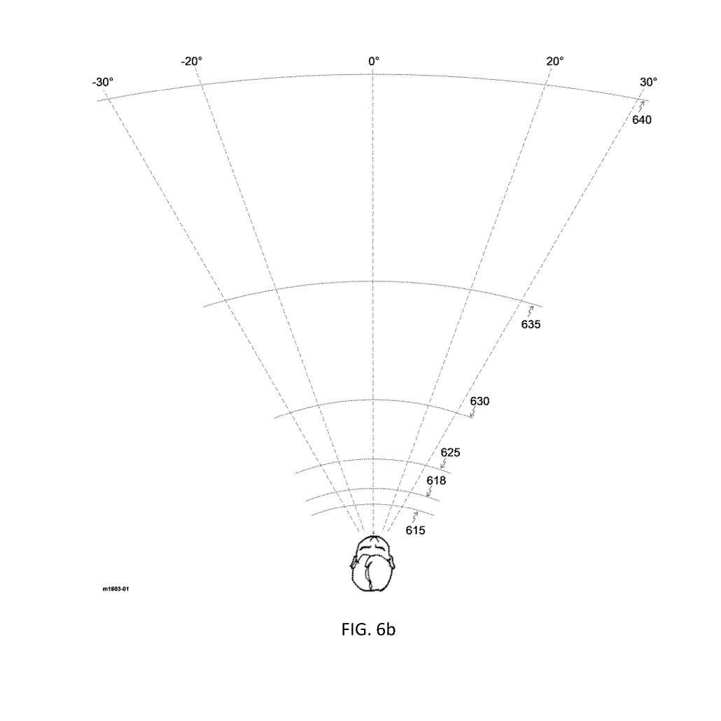

FIG. 6a illustrates an embodiment which applies the visual decompression methods of this invention within the context of a Multi-Focal Planes (Surfaces) near-eye light field display. As illustrated in FIG. 6a, in this embodiment the m-pixel and M-pixel of the light field modulators 203R and 203L would be designed to generate collimated and directionally modulated light ray bundles (or light field anglets) 610R and 610L that would collectively angularly span the FOV of the near-eye light field display 200. In this embodiment, the near-eye light field display 200 would comprise right and left sides light field modulators 203R and 203L each of which comprising multiplicity of m-pixel and M-pixel that are designed to generate multiplicity right and left light field anglets pairs 610R and 610L that address corresponding points at the viewer's right and left eyes 580R and 580L retinas. (Retinal Corresponding Points are points on the retinas of the opposing eyes of the viewer whose sensory outputs are perceived by the viewer's visual cortex as a single point at a depth.) The right and left light field anglets pairs 610R and 610L generated by the right and left light field modulators 203R and 203L; respectively, are referred to herein as “visually corresponding” when that light field anglets pair 610R and 610L addresses a set of corresponding points at the viewer's right and left eyes 580R and 580L retinas; respectively. The points within the FOV of the near-eye light field display 200 where the “visually corresponding” light field anglet pairs 610R and 610L generated by the right and left sides light field modulators 203R and 203L and relayed by the optical elements 206 to the viewer's eyes 580R and 580L intersect will be binocularly perceived by the viewer visual cortex as a virtual points of light (VPoLs) 620 within the light field modulated by the near-eye light field display system 200. The binocular perception aspects of the viewer's HVS will combine the visually corresponding anglets light bundle images relayed onto on the viewer's eyes 580R and 580L retinas by the optical elements 206 into a single viewed point of light; namely, the virtual point of light (VPoL) 620 that is perceived at a depth corresponding with the corresponding vergence distance of the viewer's eyes 580R and 580L. Thus in this embodiment, the near-eye light field display 200 modulates (or generates) virtual point of light (VPoLs) 620 to be binocularly perceived by the viewer within the display FOV by simultaneously modulating the pairs of “visually corresponding” light field anglets 610R and 610L by its the right and left sides light field modulators 203R and 203L; respectively. The position of the virtual point of light (VPoLs) 620 binocularly perceived by the viewer within the FOV the near-eye light field display 200 would be determined by the (x,y)_{R} and (x,y)_{L} spatial (coordinates) positions of the m-pixel and/or M-pixel, within the right and left light field modulators 203R and 203L, that generated the pairs of “visually corresponding” light field anglets 610R and 610L; respectively. Thus by addressing the (x,y)_{R} and (x,y)_{L} spatial positions of the m-pixel and/or M-pixel of its right and left the right and left light field modulators 203R and 203L; respectively, the near-eye light field display 200 can modulate (generate) virtual points of light (VPoLs) 620 that are binocularly perceived by the viewer at any depth within the FOV of the near-eye light field display 200. In effect with this method of VPoL 620 modulation, the near-eye light field display 200 can modulate three dimensional (3D) viewer focusable light field content within its display FOV by modulating pairs of “visually corresponding” light field anglets 610R and 610R by its the right and left sides light field modulators 203R and 203L; respectively. The term “viewer focusable” is used in this context to mean the viewer of the near-eye light field display 200 being able to focus at will on objects (or content) within the modulated light field. This is an important feature of the near-eye light field display 200 that contribute significantly to reducing the aforementioned VAC problem that typical 3D display suffer from.

Because of the intrinsic capabilities of the HVS depth perception acuity, addressing all possible virtual point of light (VPoL) 620 within the FOV the near-eye light field display 200 is not necessary. The reason is that the binocular perceptional aspects of the HVS based on which binocular depth perception is achieved in viewing objects at a given vergence distance (or position) from the viewer's eyes that forms images at corresponding regions (points) of the viewer's eyes retinas. The locus of all such positions away (or vergence distance) from the viewer's eyes is known as the Horopter surface. Combining the angular distribution of the HVS acuity with its binocular depth perception aspects produces a depth region that surrounds the Horopter surface, known as the Panum's fusion region (or volume), throughout which binocular depth perception would be achieved even though the object perceived by the viewer is not actually at the Horopter surface. This binocular depth perception volume of the Horopter surface as extended by the associated Panum's fusion region that surrounds it suggests a method for sampling the light field into a discrete set of surfaces separated by the approximate size of their Panum's fusion regions, with some overlap of course, to ensure continuity of the binocular depth perception within the volume between the light field sampling surfaces. Empirical measurements (see Hoffman, M.; Girshick, A. R.; Akeley, K. and Banks, M. S., Vergence-accommodation conflicts hinder visual performance and cause visual fatigue, Journal of Vision (2008) 8(3):33, 1-30) substantiated that binocular depth perception continuity can be achieved when multiple 2D light modulation surfaces separated by approximately 0.6 Diopter (D) are present within the viewer's field of view. The set of Horopter surfaces within the viewer's FOV that are separated by 0.6 D would, therefore, be sufficient for the viewer's HVS to achieve binocular perception within the volume that spans such a multiplicity of Horopter surfaces and their associated Panum's fusion regions. Herein the Horopter surfaces separated by the distance required to achieve viewer's binocular depth perception continuity within the FOV extending from the viewer's near to far fields will be referred to as the Canonical Horopter Surfaces.

In this embodiment, the described method of sampling the near-eye light field into a canonical (meaning sufficient to achieve continuous volumetric binocular depth perception) discrete set of Horopter surfaces separated by 0.6 D (Horopter surfaces separation distance) would be accomplished using the described virtual point of light (VPoL) 620 modulation method of the near-eye light field display 200 described in an earlier embodiment by defining the set of (x,y)_{R} and (x,y)_{L} spatial positions of the m-pixel and/or M-pixel, within the right and left light field modulators 203R and 203L; respectively, that would generate the set of “visually corresponding” light field anglets that would subsequently cause viewer's binocular perception of the multiplicity of virtual points of light (VPoLs) 620 at the selected canonical set of Horopter surfaces within the display system 200 FOV. With this method of modulating the canonical set of Horopter surfaces using the described virtual points of light (VPoLs) 620 modulation method, the near-eye light field display 200 would be able to perceptionally address the entire near-eye light field of the viewer. In effect, therefore, the methods of this embodiment would achieve a light field compression gain that is proportional to the size (in VPoLs) of the selected Horopter modulation surfaces relative to the size (in VPoLs) of the entire light field addressable by the near-eye light field display 200, which could be a sizable compression gain that is expected to be well in excess of 100×. It is worth noting that such a compression gain is achieved by the virtual points of light (VPoLs) 620 modulation capabilities of the near-eye light field display 200 in matching the binocular perception and angular acuity of the HVS.

FIG. 6b illustrates the near-eye light field Horopter sampling and modulation methods of the previous embodiments. FIG. 6b shows a top view of the light field Horopter surfaces 615, 618, 625, 630, 635 and 640 relative to position of the viewer's eyes 610 systematically from near-field (˜30 cm) toward the far-field (˜300 cm) of the viewer. As FIG. 6b shows, the first light field Horopter surface 615 would be at the viewer's near-field distance located at 3.33 D from the viewer's eyes while the remaining five light field Horopter surfaces 618, 625, 630, 635 and 640 would be located at successive 0.6 D distance from the viewer's eyes at 2.73 D, 2.13 D, 1.53 D, 0.93 D and 0.33 D; respectively, from the viewer's eyes. The six light field Horopter surfaces 615, 618, 625, 630, 635 and 640 illustrated in FIG. 6b will each be comprised of a multiplicity of VPoLs 620 modulated at a density (or resolution) that is commensurate with the HVS depth and angular acuities; for example, the modulated VPoLs 620 density (spot size) at the first light field Horopter surface 615 would be 40 micron to match the HVS spatial acuity at that distance, and becoming successively larger at the remaining five light field Horopter surfaces 618, 625, 630, 635 and 640 in a manner that matches the HVS spatial and angular acuity distribution. The multiplicity of VPoLs 620 comprising each one of the six light field Horopter surfaces 615, 618, 625, 630, 635 and 640 would be modulated (generated) by their associated multiplicity of “visually corresponding” light field anglet pairs 610R and 610L generated by the defined sets of m-pixel and/or M-pixel located at their respective (x,y)_{R} and (x,y)_{L} spatial positions within the right and left light field modulators 203R and 203L; respectively, of the near-eye light field display 200. The spatial positions (x,y)_{R} and (x,y)_{L} within the right and left light field modulators 203R and 203L that modulate (generate) each of the six light field Horopter surfaces 615, 618, 625, 630, 635 and 640 would be computed a priori and maintained by the Visual Decompression Transform block 302 to address their corresponding VPoLs 620 comprising each one of the six light field Horopter surfaces 615, 618, 625, 630, 635 and 640 based on the light field image data 301 it receives as an input from either an embedded or an external processor 102 or 107; respectively.

Depth Foveated Visual Decompression in Multi-Focal Planes Light Field—

Although the right and left light field modulators 203R and 203L of the near-eye light field display system 200 could possibly modulate all six light field Horopter surfaces 615, 620, 625, 630, 635 and 640 simultaneously, that should not be necessary since at any specific instant the viewer's eyes would be focused at a specific distance and, as explained earlier, the HVS depth perception acuity is at its highest value within the vicinity of that point and reduces systematically with either depth or angular deviations from that point. Therefore, in this embodiment the multi-focal planes near-eye display system 200 of this invention achieves visual compression gain by using the multi-focal surfaces light field modulation methods of this invention with the six light field Horopter surfaces 615, 618, 625, 630, 635 and 640 being modulated simultaneously but at a VPoLs 620 density (resolution) that matches the HVS acuity at the viewer point of focus. In addition, in an embodiment that incorporates within the near-eye display system 200 both the described methods of modulating the near-eye light field using VPoLs 620 that modulate the canonical Horopter surfaces 615, 618, 625, 630, 635 and 640 as illustrated in FIG. 6b and the Foveated Visual Decompression methods described in the previous embodiments, the sensed point of focus of the viewer provided by the eye & head tracking element 210 sensor is used to determine (identify) the Horopter surfaces contributing the most visual information within the vicinity of the point where the viewer's eyes are focused and the described Foveated Visual Decompression methods are then applied to proportionally compress the VPoLs 620 modulating the six light field Horopter surfaces 615, 620, 625, 630, 635 and 640 in proportion to their contribution to visual information within the vicinity where the viewer's eyes are focused. In this embodiment, the sensed point of focus of the viewer provided by the eye & head tracking element 210 sensor is used to identify the light field Horopter surfaces within less than 0.6 D from where the viewer's eyes are focused (vergence distance). This criterion will identify at most two of the canonical light field Horopter surfaces 615, 618, 625, 630, 635 and 640 when the viewer's focus point is not directly on one of these surfaces, in which case only one of the Horopter surface would be identified. As explained earlier, since the binocular fusion region of the viewer's HVS in effect fills in the 0.6 D regions in between the canonical light field Horopter surfaces, this criterion ensures that the viewer's optical depth of focus region falls within the binocular fusion region of at least one of the selected (identified) light field Horopter surfaces. In this embodiment, the Horopter surfaces identified using the described selection criterion contribute the most visual information within the vicinity of the point where the viewer's eyes are focused and accommodating, accordingly the multi-focal planes light modulator (display) elements 203R and 203L of FIG. 6a would modulate these identified Horopter surfaces to achieve the highest visual perception using VPoLs 620 density that matches the HVS acuity at the sensed depth of these surfaces and also using the highest number of modulation basis coefficients at a minimal word-length truncation while the remainder of Horopter surfaces having lesser contribution within the vicinity of the point where the viewer's eyes are focused would be modulated by the multi-focal planes light modulator (display) element 203R and 203L of FIG. 6a using fewer VPoLs 620 spaced at a wider angular pitch using proportionally lesser number of modulation basis coefficients at a higher word-length truncation. The net effect of the methods of this embodiment is a three dimensional Foveated Visual Decompression action in which the visual information within the vicinity of the point where the viewer's eyes are focused would be modulated at the highest fidelity, that matches the HVS perceptional acuity at the point of focus, while the visual information of surrounding regions are modulated at a fidelity level that matches the proportionally lesser perceptional acuity of the HVS at points away from (in front, back or sides) where the viewer's eyes are focused. The combined methods of this embodiment are referred to collectively as Multi-Focal Planes Light Field Depth Foveated Visual Decompression. It should be noted that the term “foveated” used within the context of this embodiment is meant to indicate that the display resolution would be adapted to the HVS depth perception acuity profile (distribution) from the center of the viewer's eyes fovea outward toward the peripheral region of the viewer's eyes retina.

It should be noted that although in the previous embodiment a higher density of VPoLs 620 would be modulated by the display elements 203R and 203L of FIG. 6a onto the viewer's eye fovea central regions (402-404 of FIG. 4a) as indicated by the eye & head tracking element 210, the display element 203R and 203L of FIG. 6a would still be able to modulate the highest VPoLs 620 density possible across an angular region that extends across the angular distance between the viewer's near and far fields, which is a total of approximately 7°. Nonetheless, when the depth Foveated Visual Decompression methods of the previous embodiments are applied it would truncate and quantize the modulation basis coefficients in a way that matches the HVS angular and depth perceptional acuity, as explained earlier, thus in effect compounding the compression gains of the Foveated Visual Decompression and the foveated multi-focal plains light modulator (display) element 203R and 203L of FIG. 6a. That is to say with the previous examples when the Foveated Visual Decompression that achieves a moderate compression gain factor of 32× is combined with the described the foveated multi-focal planes light modulator elements 203R and 203L of FIG. 6a that achieves a compression gain factor of approximately 3× (in selecting at most only two of the six canonical Horopter surfaces while also foveating the VPoLs 620 density of all six canonical Horopter surfaces), the compound compression that can be achieved by the near-eye light field display system 200 in this case would reach a gain factor of 96× in comparison with a near-eye display system that achieves comparable viewing experience and using a near-eye light field display having six focal planes capability.

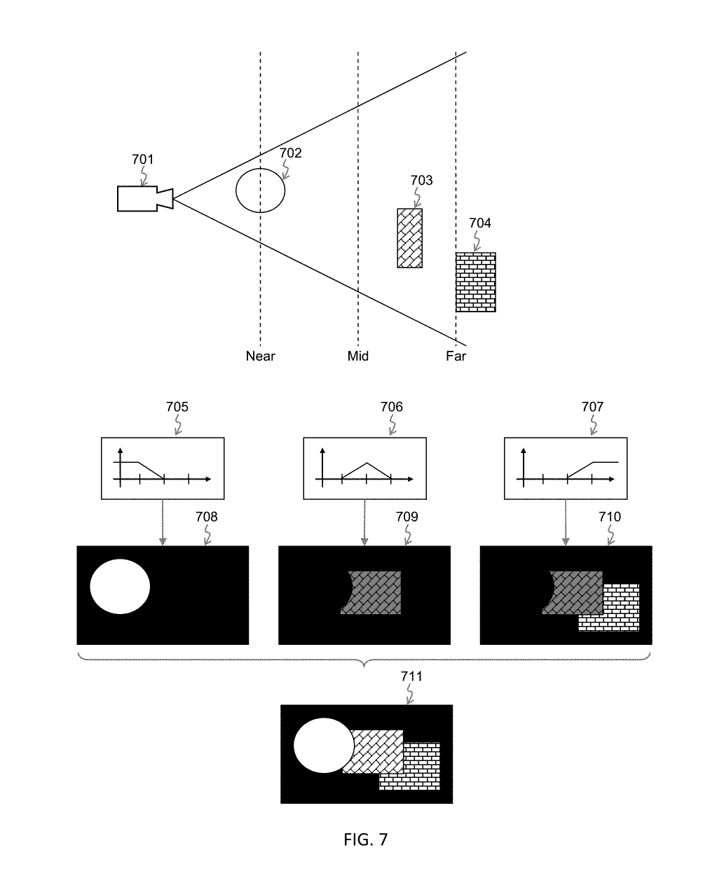

FIG. 7 illustrates the generation of content for the multi-focal planes near-eye light field display 200 of FIG. 6a. In this illustrative example, the scene is captured by the camera 701 in three depth planes: a near plane, a middle plane and a far plane. Notice that the more depth planes captured by the camera 701, the better would the viewer's depth perception at the multi-focal planes light field near-eye display 200 of FIG. 6a. Preferably the number of capture depth planes should be commensurate with the number of focal planes light field near-eye display 200 of FIG. 6a can modulate, which in case of the previous embodiments were the six canonical Horopter surfaces 615, 618, 625, 630, 635 and 640 of FIG. 6b. This example uses three capture planes to illustrate additional aspects of this invention, however, a person skilled in the art would be able to use the methods described herein to realize a multi-focal planes near-eye imaging (meaning capture and display) system that make use of more than the three captured depth planes of this illustrative example. In this illustrative example, three objects are placed in the content scene, an object 702 closer to the capture camera, and two other objects 703 and 704 farther away from the camera. For a multi-focal planes imaging system, an adjustment in the brightness of the objects according to their position relative to the (capture) depth layers would be needed. In the illustrative example of FIG. 7, this is accomplished by depth filtering, as illustrated by filtering blocks 705, 706 and 707, of the brightness of the image content in order to make the brightness of the image scene objects commensurate with their depth value. For example, the closest object 702 is entirely contained in the first depth layer, so it would be depicted with full brightness in that particular layer 708, but is completely removed from the other two layers 706 and 707. In the case of the middle object 703, it is situated between two depth layers (middle and far), therefore, its full brightness would be divided between the two layers 706 and 707, in order to render the full brightness of the object 703. However, since the perceived object brightness is the summation of all layers 711, the objects will be perceived with full brightness at the viewer's eye as a weighted sum of the brightness contributions from both depth planes 706 and 707. In order to realize the 3D perception of the scene, each of the depth layers 708, 709 and 710 would be displayed to the viewer at its corresponding depth, where the adjusted brightness would be consistent with the scene objects depth in order to effectively evoke the viewer depth cues and make the displayed content focusable by the viewer. The viewer would see a combination of all layers, resulting in the reconstructed stereo image 711, with the appropriate focus cues to the viewer's HVS. The image content of the three capture planes of this illustrative example together with their relative depth information would be rendered, as explained above, in order to distribute (or map) their image content color and brightness onto the multi-focal planes of the multi-focal planes near-eye display 200 of FIG. 6a. The end result of this captured image rendering process is the mapping of the input image 301 content color and brightness onto a data set that specifies the color and brightness data of the multiplicity of “visually corresponding” light field anglet pairs 610R and 610L that would be generated by their respective sets of m-pixel and/or M-pixel (x,y)_{R} and (x,y)_{L} spatial positions within the right and left light field modulators 203R and 203L; respectively, of the near-eye light field display 200. In modulating these color and brightness data sets by the right and left light field modulators 203R and 203L; respectively, of the near-eye light field display 200, the viewer would perceive the rendered 3D image input content as a modulated set of VPoLs 620 and would be able to focus at will at any of the displayed 3D objects 702, 703 or 704 in the scene. It should be noted that although in the preceding illustrative example only three capture planes were used, the near-eye light field display 200 of this invention would still in this case render, using the described methods of this embodiment, the input image data 301 onto its six canonical Horopter surfaces of FIG. 6b for display of the input image content using its near-eye light field display capabilities using the described VPoLs 620 modulation method.

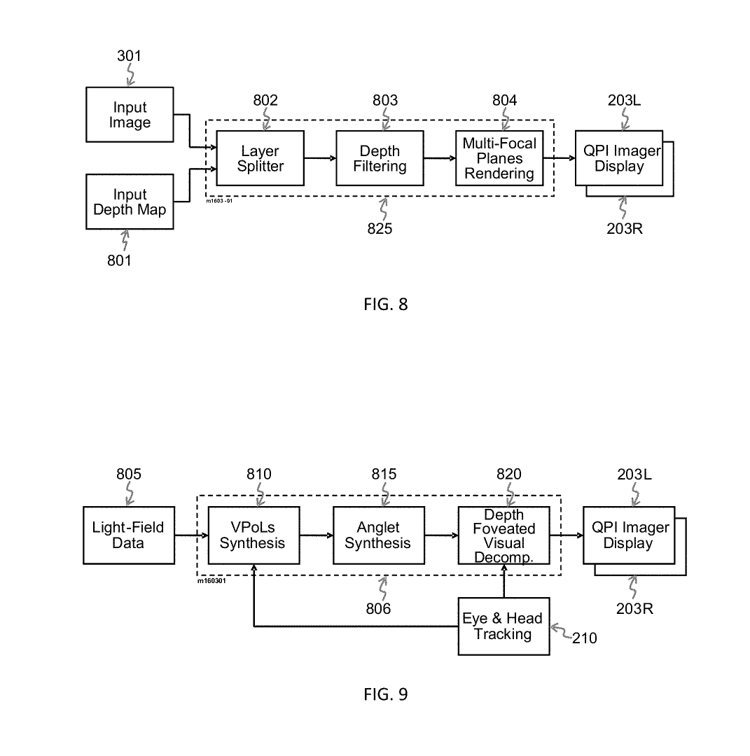

The multi-focal planes depth filtering process illustrated in FIG. 7 is effectively the process of allocating (or mapping) the input image scene content brightness, in accordance with the associated input image depth information, to the display 200 multi-focal planes with the objective to create the appropriate perceptional depth cue to the viewer's HVS. In one embodiment of this invention, the multi-focal planes near-eye light field display 200 of this invention is able to perform local depth filtering process in order to generate all the depth layers used by the near-eye light field display 200 of FIG. 6a, which in the case of the preceding embodiment were the six canonical Horopter surfaces located within the display FOV from the near to far fields of the viewer as illustrated in FIG. 6b. FIG. 8 illustrates the multi-focal planes depth filtering methods 825 of this embodiment whereby the layer splitter 802 processes the image input 301 and its associated depth map 801 to generate the image depth planes or layers, which corresponds to the capture depth planes. The content of each generated layer is then depth filtered 803 in order to map the input image 301 and its associated input depth map 602 onto multi-focal planes images to be displayed. The image render block 804 then uses the generated multi-focal planes images to generate color and brightness values of the multiplicity of “visually corresponding” light field anglet pairs 610R and 610L that would be generated by their respective sets of m-pixel and/or M-pixel (x,y)_{R} and (x,y)_{L} spatial positions within the right and left light field modulators 203R and 203L; respectively, of the near-eye light field display 200 that would modulated the multi-focal planes VPoLs 620 to the viewer of the display.

In another embodiment, the display images for the canonical light field Horopter surfaces 615, 620, 625, 630, 635 and 640 of the near-eye light field display 200 of the previous embodiments are generated from the input image 301 that is comprised of compressed set of reference elemental images or holographic elements (hogels) (see U.S. Patent Application Publication No. 2015/0201176) of the captured scene content. In this embodiment, the elemental images or hogels captured by a light field camera of the scene are first processed in order to identify the subset of minimal number of captured elemental images or hogels that contribute the most or sufficiently represent the image contents at the (designated) depths of the canonical light field Horopter multi-focal surfaces 615, 620, 625, 630, 635 and 640. This identified subset of elemental images or hogels are herein referred to as Reference Hogels. Relative to the data size of the total number of the elemental images or hogels captured by the source light field camera of the scene, the data size of the identified Reference Hogels containing the image content of the canonical multi-focal surfaces 615, 618, 625, 630, 635 and 640 would represent a compression gain that is inversely proportional to the data size of identified subset of Reference Hogels divided by the total number of captured elemental images or hogels, a compression gain which could reach more than 40× of compression gain. Thus in this embodiment the captured light field data set is compressed into the data set representing the discrete set of multi-focal surfaces of the near-eye light field display 200 and in so doing a compression gain is realized that reflects the canonical light field Horopter multi-focal surfaces 615, 618, 625, 630, 635 and 640, identified by the methods of the previous embodiment, as being a compressed representation of the light field that achieves compression gain by matching the viewer's HVS depth perception aspects.

Compressed Rendering—

In another embodiment, illustrated in FIG. 9, “compressed rendering” (U.S. Patent Application Publication No. 2015/0201176) is performed directly on the received image input 805 comprising the compressed light field data set of reference hogels of the previous embodiment in order to extract the images to be displayed by the multi-focal planes near-eye light field display 200 the right and left light field modulators 203R and 203L for modulating the light field images at the canonical light field Horopter multi-focal surfaces 615, 618, 625, 630, 635 and 640. FIG. 9 illustrates the compressed rendering process 806 of this embodiment in which input light field data 805, comprising the compressed light field data set of reference hogels, is processed to generate the input to the multi-focal planes near-eye light field display 200 right and left light field modulators 203R and 203L. In the compressed rendering process 806 of FIG. 9, the received compressed input image 805 comprising the light field data set of reference hogels of the previous embodiment is first rendered to extract the light field images at the canonical light field Horopter multi-focal surfaces 615, 620, 625, 630, 635 and 640. In the first step 810 of the compressed rendering process 806 the reference hogels images together with their associated depth and texture data, which comprise the light input 805, are used to synthesize the color and brightness values of the near-eye light field VPoLs comprising each of the canonical light field Horopter multi-focal surfaces 615, 618, 625, 630, 635 and 640. Since the reference hogels were a priori selected based on the depth information of the canonical light field Horopter multi-focal surfaces 615, 618, 625, 630, 635 and 640, the VPoLs synthesis process 810 would require the minimal processing throughput and memory to extract the near-eye light field VPoLs color and brightness values from the compressed reference hogels input data 805. Furthermore, as illustrated in FIG. 9, the viewer's gaze direction and focus depth sensed by the eye and head tracking element 210 are used by the VPoLs synthesis process 810 to render the VPoLs values based on the viewer's HVS acuity distribution profile relative to the sensed gaze direction and focus depth of the viewer. Associated with each of the synthesized near-eye light field VPoLs values would be a pair of visually corresponding anglet directions and their (x,y)_{R} and (x,y)_{L} spatial positions coordinates within the right and left light field modulators 203; respectively, of the near-eye light field display 200. The color and brightness values of visually corresponding anglet pairs associated with each of the extracted near-eye light field VPoLs is then mapped (transformed) onto the (x,y)_{R} and (x,y)_{L} spatial positions coordinates within the right and left light field modulators 203R and 203L; respectively, by the anglet synthesis process 815. Depending on the viewer's gaze direction sensed by the head and eye tracking element 210, the depth foveated visual compression block 820 would utilize the described methods of previous embodiments to compress the generated color and brightness values for the (x,y)_{R} and (x,y)_{L} spatial positions coordinates within the right and left light field modulators 203R and 203L; respectively, based the viewer's HVS acuity distribution. In essence this embodiment would combine compression gains of three of the previous embodiments; namely, (1) the gain associated with the compression of the light field data input into the set of minimal reference hogels that fully comprise the canonical light field multi-focal surfaces; (2) the gain associated with the compression of the entire light field into the set of VPoLs comprising each of the canonical light field multi-focal surfaces; and (3) the gain associated with the depth foveation of the modulated VPoLs to match the angular, color and depth acuity of the viewer's HVS. The first of these compression gains will substantially reduce the interface bandwidth of the near-eye display system 200; the second of these compression gains will substantially reduce the computational (processing) resource required the VPoLs and their generating corresponding anglets; and the third of these compression gains will substantially reduce the interface bandwidth of the near-eye display light field modulators 203R and 203L. It should be noted that the effect of these compression gains are further enhanced by the compressed display capabilities of the near-eye display light field modulators 203R and 203L that enable the display of the compressed input directly without the need to decompress it first as currently being done in prior art display systems.

The preceding description of multiple embodiments presented image compression methods for near-eye display systems that reduce the input bandwidth and the system processing resource. High order basis modulation, dynamic gamut, light field depth sampling and image data word-length truncation and quantization aiming at matching the human visual system angular, color and depth acuity coupled with use of compressed input display enable high fidelity visual experience in near-eye display systems suited for mobile applications at a substantially reduced input interface bandwidth and processing resource.

Those skilled in the art will readily appreciate that various modifications and changes can be applied to the embodiments of the invention without departing from its scope defined in and by the appended claims. It should be appreciated that the foregoing examples of the invention are illustrative only, and that the invention can be embodied in other specific forms without departing from the spirit or essential characteristics thereof. For example, various possible combinations of the disclosed embodiments can be used together in order to achieve further compression gain in a near-eye display design that is not specifically mentioned in the preceding illustrative examples. The disclosed embodiments, therefore, should not be considered to be restrictive in any sense either individually or in any possible combination. The scope of the invention is indicated by the appended claims, rather than the preceding description, and all variations which fall within the meaning and range of equivalents thereof are intended to be embraced therein.

What is claimed is:

1. A method of forming a near-eye display comprising:
optically coupling at least one image display element to a near-eye display viewer's eyes with at least one corresponding optical element;
electrically coupling an image processor element to an encoder element and coupling the encoder element to the image display element, either by embedding the image processor element and encoder element within the near-eye display system within a vicinity of the viewer's eyes, or remotely locating the image processor element and encoder element away from the viewer's eyes and coupling the encoder element to the near-eye display system either wirelessly or by wired connection;
optically coupling at least one eye and head tracking element in the near-eye display to sense a near-eye display viewer's eye gaze direction and focus distance; and
coupling an output of the eye and head tracking element to the image processor and encoder elements;
whereby the image processor element provides image data to the encoder element and the encoder element provides compressed image data to the near-eye display element.

2. The method of claim 1 wherein the image display element directly displays the image content of the compressed image data it receives from the encoder element without first decompressing the compressed image data.

3. The method of claim 1 wherein the encoder compresses the image data into a compressed image data format, and the image display element directly displays the image content of the compressed image data format it receives from the encoder element without first decompressing the compressed image data.

4. The method of claim 3 wherein the compressed image data is formatted in reference to a set of high order macros comprising a multiplicity of n×n pixels with basis modulation coefficients of the macros being expansion coefficients of either discrete Walsh, discrete Wavelet or discrete Cosine image transforms.

5. The method of claim 3 wherein the image display element modulates the compressed image data at a sub-frame rate that causes a near-eye display system viewer's human visual system to integrate and directly perceive compressed image data as a decompressed image.

6. The method of claim 3 wherein the compressed image data format is referenced to an image frame or sub-frame color gamut wherein the encoder element embeds the image frame or sub-frame color gamut within the compressed image data format, and wherein the image display element dynamically adjusts its color gamut at a frame or sub-frame rate of the compressed image data format in order and modulates the compressed image data directly in reference to the image frame or sub-frame color gamut embedded in the compressed image data format.

7. The method of claim 4 wherein the encoder element comprises:
a visual decompression transform element that extracts the basis modulation coefficients from the image data;
a quantizer element that first truncates the extracted basis modulation coefficients into a subset of extracted modulation coefficients based on a coefficients set truncation criterion, the quantizer element further quantizing a selected subset of extracted modulation coefficients using a word-length that is shorter than a word length of the extracted subset of basis modulation coefficients based on a coefficients set quantization criterion; and
a run-length encoder element that temporally multiplexes the truncated and quantized subset of extracted basis modulation coefficients and sends the multiplexed truncated and quantized subset of extracted basis modulation coefficients as the compressed image data.

8. The method of claim 7 wherein the coefficients set truncation criterion discards extracted basis modulation coefficients associated with image transforms having a temporal response of a higher frequency than temporal perception acuity limits of a near-eye display system viewer's visual system.

9. The method of claim 7 wherein the coefficient set quantization criterion selects successively shorter word lengths for the image transforms having temporal responses of higher frequencies.

10. The method of claim 7 wherein the coefficient set quantization criterion further selects a word length that is proportional with a frame or frame region gamut size relative to an image display element standard gamut size such that the smaller the conveyed frame or frame region gamut size relative to the image display element standard gamut size, the smaller the word length that is used to express a color coordinate of selected image transforms.

11. The method of claim 4 wherein the encoder element further comprises:
a visual decompression transform element that extracts the basis modulation coefficients for the set of (n×n) high order macros from the compressed image data based on a viewer's gaze direction sensed by the eye and head tracking element;
a foveated quantizer element that makes use of the viewer's gaze direction sensed by the eye and head tracking element to first truncate the extracted set of basis modulation coefficients into a subset of basis modulation coefficients based on a coefficients set truncation criterion, the foveated quantizer element further quantizing the subset of basis modulation coefficients using a word-length that is shorter than a word length of the extracted subset of basis modulation coefficients based on a coefficients set quantization criterion; and
a run-length encoder element temporally multiplexing the truncated and quantized subset of basis modulation coefficients and coupling the multiplexed truncated and quantized subset of basis modulation coefficients to the image display element as the compressed image data.

12. The method of claim 11 wherein the basis modulation coefficients set truncation criterion discards extracted basis modulation coefficients associated with basis modulation coefficients having a temporal response of a higher frequency than temporal perception acuity limits of a near-eye display system viewer's visual system.

13. The method of claim 11 wherein the basis modulation coefficients set truncation criterion selects a greater number of extracted basis modulation coefficients for a central region of a viewer's eyes' field of view, as determined by the viewer's gaze direction sensed by the eye and head tracking element, and successively fewer basis modulation coefficients toward peripheral regions of the viewer's eyes' field of view.

14. The method of claim 11 wherein the basis modulation coefficients set quantization criterion selects successively shorter word lengths for the basis modulation coefficients having temporal responses of higher frequencies and further selects longer word lengths for the quantization of basis modulation coefficients for a central region of a viewer's eyes' field of view, as determined by the viewer's gaze direction sensed by the eye and head tracking element, and selects successively shorter word lengths for the quantization of basis modulation coefficients toward peripheral regions of the viewer's eyes' field of view.

15. The method of claim 11 wherein the basis modulation coefficients set truncation criterion selects higher order macros of the compressed image data for a central region of a viewer's eyes' field of view, as determined by the viewer's gaze direction sensed by the eye and head tracking element, and successively selects lower order macros for peripheral regions of the viewer's eyes' field of view, as determined by the viewer's gaze direction sensed by the eye and head tracking element.

16. The method of claim 11 wherein the basis modulation coefficients set truncation criterion selects a word length that is dependent on a color acuity profile of a near-eye display system viewer's human visual system such that successively shorter word lengths are used to express basis modulation coefficients based on a display color gamut that is dependent on the viewer's human visual system color acuity profile relative to the viewer's eyes gaze direction.

17. The method of claim 1 using a reflector and beam splitter optical assembly, a free-form optical wedge or wave guide optics.

18. A method of forming a near-eye light field display system comprising:
optically coupling at least one light field image display element to each of a near-eye light field display viewer's eyes with corresponding optical elements;
electrically coupling an image processor element to an encoder element and coupling the encoder element to the image display elements, either by embedding the image processor and encoder elements within the near-eye light field display system within a vicinity of the viewer's eyes, or remotely locating the image processor and encoder elements away from the viewer's eyes and coupling the encoder element to the near-eye light field display system either wirelessly or by wired connection;
optically coupling at least one eye and head tracking element in the near-eye light field display system to sense each of a near-eye display viewer's eye gaze direction and focus distance; and
coupling an output of the eye and head tracking element to the image processor and encoder elements;
whereby the image processor element provides light field image data to the encoder element and the encoder element provides compressed light field image data to the light field image display elements.

19. The method of claim 18 wherein the light field image display elements modulate respective sides of a near-eye light field viewer's human visual system with samples of a light field to be displayed to a near-eye light field display system viewer, either as multiple views or as multiple focal planes samples, using groups of multiple (m×m) physical pixels of each of right side and left side light field image display elements of the near-eye light field display system.

20. The method of claim 19, wherein the light field samples are modulated by the right side and left side light field image display elements of the near-eye light field display system, each being a collimated and directionally modulated light bundle or anglet, that are coupled onto the corresponding optical elements through a set of micro optical elements, each micro optical element being associated with a respective one of the physical pixels, comprising an optical aperture of each set of micro optical elements within each group of multiple (m×m) physical pixels of the right side and left side light field image display elements.

21. The method of claim 20 wherein each set of micro optical elements associated with each of the physical pixels and each of the groups of multiple physical pixels of the light field image display elements collimate and directionally modulate the anglets at an angular density of anglets that is higher within a central region of an optical aperture of the light field image display elements than the angular density of anglets within peripheral regions of the light field image display elements.

22. The method of claim 21 wherein a distribution of the angular density of anglets from the central to peripheral regions of the light field image display elements is proportional to an angular distribution of a viewer's human visual system acuity, enabling a highest angular density of anglets to be optically coupled onto a viewer's eye's retina central region with a systematically reduced angular density of anglets optically coupled onto a viewer's eye's retina peripheral regions.

23. The method of claim 18 wherein a central region of an optical aperture of the light field image display elements is provided with the highest density of anglets, sufficiently wide in angular width to accommodate a viewer's eye movements between a near field and a far field of the viewer of the near-eye light field display system.

24. The method of claim 19 wherein a central region of an optical aperture of the light field image display elements is provided with the highest density of anglets, sufficiently wide in angular width to accommodate a viewer's eye movements between a near field and a far field of the viewer of the near-eye light field display system, and wherein the light field image display elements present to the viewer a set of multi-view samples of the light field wherein a dimensionality of the groups of multiple physical pixels at the central optical region of the light field image display elements, when coupled to the viewer's eyes through the optical elements, project a spot size that matches an average spatial acuity of a viewer's eye's retinal central region.

25. The method of claim 18 wherein the light field image display elements modulate a higher number of views onto a viewer's central fovea regions and systematically fewer number of views onto peripheral regions of a viewer's field of view, thereby matching a viewer's human visual system angular acuity and depth perception.

26. The method of claim 19 wherein the light field image display elements directly display image content of the compressed image data received from the encoder element without first decompressing the compressed image data, and wherein the encoder element provides compressed image data within a vicinity of a point where the viewer's eyes are focused, based on a sensed point of focus of the viewer provided by the eye and head tracking element, modulated at a highest fidelity that matches a viewer's human visual system perceptional acuity at the sensed point of focus of the viewer, while visual information of surrounding regions is modulated at a fidelity level that matches a proportionally lesser perceptional acuity of the viewer's human visual system at points away from where the viewer's eyes are focused, thereby providing a Depth Foveated Visual Decompression capability to realize the near-eye light field display system to achieve a three dimensional Foveated Visual Decompression by the light field image display elements.

27. The method of claim 19 wherein the near-eye light field display system modulates a focusable light field to a viewer by modulating a pair of visually corresponding anglets from its right and left eye light field image display elements that are perceived by the viewer's human visual system as a virtual point of light within the light field image display elements' field of view at a given depth as determined by spatial coordinates of the physical pixel groups of the right and left side light field image display elements that generated the pair of visually corresponding anglets.

28. The method of claim 18 wherein the near-eye light field display system presents to a viewer a set of multi-focal surface samples whereby multi-focal planes are a set of canonical Horopter surfaces extending from a viewer's near field depth to a viewer's far field depth, the surfaces being nominally separated by 0.6 Diopter.

29. The method of claim 19 wherein the near-eye light field display system modulates a focusable light field to a viewer by modulating a pair of visually corresponding anglets from its right and left eye light field image display elements that are perceived by the viewer's human visual system as a virtual point of light within the light field image image display elements' field of view at a given depth as determined by spatial coordinates of the physical pixel groups of the right and left side light field image display elements that generated the pair of visually corresponding anglets, and wherein the near-eye light field display system presents to the viewer a set of multi-focal surface samples whereby multi-focal surfaces are a set of canonical Horopter surfaces extending from a viewer's near field depth to a viewer's far field depth, the canonical Horopter surfaces being nominally separated by 0.6 Diopter, the near-eye light field display system modulating the canonical Horopter surfaces using virtual points of light achieving a light field modulation compression gain that is proportional to a size in virtual points of light of the selected canonical Horopter surfaces relative to a size in virutal points of light of the entire light field addressable by the near-eye light field display system.

30. The method of claim 19 wherein the near-eye light field display system modulates a focusable light field to a viewer by modulating a pair of visually corresponding anglets from its right and left eye display elements that are perceived by the viewer's human visual system as a virtual point of light within the light field image display elements' field of view at a given depth as determined by spatial coordinates of the physical pixel groups of the right and left side light field image display elements that generated the pair of visually corresponding anglets, and wherein the near-eye light field display system presents to the viewer a set of multi-focal surface samples whereby multi-focal surfaces are a set of canonical Horopter surfaces extending from a viewer's near field depth to a viewer's far field depth, the canonical Horopter surfaces being nominally separated by 0.6 Diopter, a density of the modulated virtual points of light comprising each of the canonical Horopter surfaces matching a viewer's human visual system depth and angular acuities at a corresponding distance of the canonical Horopter surfaces from the viewer.

31. The method of claim 26 wherein the near-eye light field display system modulates a focusable light field to a viewer by modulating a pair of visually corresponding anglets from its right and left side light field image display elements that are perceived by the viewer's human visual system as a virtual point of light within the light field image display elements' field of view at a given depth as determined by spatial coordinates of the physical pixel groups of the right and left side light field image display elements that generated the pair of visually corresponding anglets, and wherein the near-eye light field display system presents to the viewer a set of multi-focal surface samples whereby multi-focal surfaces are a set of canonical Horopter surfaces extending from a viewer's near field depth to a viewer's far field depth, the canonical Horopter surfaces being nominally separated by 0.6 Diopter, the near-eye light field display system modulating the canonical Horopter surfaces using virtual points of light, achieving a light field modulation compression gain that is proportional to a size in virtual points of light of the selected canonical Horopter surfaces relative to a size in v of the entire light field addressable by the near-eye light field display to realize both a combined light field modulation gain and a visual compression gain.

32. The method of claim 26 wherein the compressed light field image data is formatted in reference to a set of high order macros comprising a multiplicity of m×m pixels with modulation basis modulation coefficient of the macros being basis modulation coefficients of either discrete Walsh, discrete Wavelet or discrete Cosine image transforms, wherein the sensed point of focus of the viewer provided by the eye and head tracking element is used to identify the canonical Horopter surfaces within less than 0.6 Diopter from where the viewer's eyes are focused, then to modulate the identified canonical Horpotor surfaces to achieve a highest visual perception using a VPoLs density that matches the viewer's human visual system acuity at a sensed depth of the identified canonical Horpotor surfaces and using a highest number of the basis modulation coefficients at a minimal word-length truncation with the remainder of the canonical Horpotor surfaces having lesser contribution within the vicinity of the point where the viewer's eyes are focused being modulated using fewer VPoLs that are spaced at a wider angular pitch and using a proportionally lesser number of the basis modulation coefficients at a higher word-length truncation, thereby incorporating Depth Foveated Visual Decompression.

33. The method of claim 28 further performing local depth filtering to generate all the set of canonical Horopter surfaces used to modulate image content incorporating commensurate depth cues to enable the viewer's human visual system to perceive a captured depth of a displayed content.

34. The method of claim 28 wherein the light field image data comprises a compressed set of reference elemental images or hogels of a captured scene content that identify a subset of a minimal number of captured elemental images or hogels that contribute most of, or sufficiently represent, image contents at depths of the canonical light field Horopter surfaces, and wherein the near-eye light field display system renders display images for the canonical light field Horopter surfaces from the compressed set of reference hogels of the captured scene content that identify the subset of the minimal number of captured hogels that contribute most of, or sufficiently represent, image contents at the depths of the canonical light field Horopter surfaces, thus realizing a compression gain that is inversely proportional to a data size of the identified subset of reference hogels divided by a total number of captured elemental images or hogels.

35. The method of claim 34 using compressed rendering directly on the compressed set of reference hogels to extract the image contents to be displayed by the right and left side image display elements for modulating display images at the canonical Horopter surfaces.

36. The method of claim 18 using a reflector and beam splitter optical assembly, a free-form optical wedge or wave guide optics.
